(19) United States
(12) Patent Application Publication
(10) Pub. No.: US 2014/0111558 A1
(43) Pub. Date: Apr. 24, 2014

(54) DISPLAY DEVICE AND PROGRAM

(71) Applicant: SEMICONDUCTOR ENERGY LABORATORY CO., LTD., Atsugi-shi (JP)

(72) Inventors: Tetsuji ISHITANI, Atsugi (JP); Yoshiharu Hirakata, Ebina (JP); Shunpei Yamazaki, Tokyo (JP)

(73) Assignee: SEMICONDUCTOR ENERGY LABORATORY CO., LTD., Atsugi-shi (JP)

(21) Appl. No.: 14/056,986

(22) Filed: Oct. 18, 2013

(30) Foreign Application Priority Data
Oct. 23, 2012 (JP) 2012-234121
Nov. 30, 2012 (JP) 2012-262310

(51) Int. Cl. G09G 5/10

(52) U.S. Cl. CPC G09G 5/10
USPC 345/690

(57) ABSTRACT

Provided are a display device and the driving method of the display device with which eye fatigue of a user in long-term use of the display device is reduced. The display device includes a display unit, a detection unit, and a control unit. The detection unit detects a condition of a user's eye to obtain detected information and transmits the detected information to the control unit. The control unit extracts fatigue information on the user from the detected information and drives the display unit such that a luminance of light with a wavelength shorter than or equal to a predetermined wavelength among light emitted from the display unit is changed on the basis of the fatigue information.

### BACKGROUND OF THE INVENTION

1. Field of the Invention

The present invention relates to a display device for displaying images and to a program for driving the display device.

2. Description of the Related Art

Display devices such as liquid crystal display devices are used for a television, a monitor of a personal computer (PC), a display of a laptop PC, a display of a portable information terminal, and the like.

It is known that short-wavelength light is related to eye fatigue of a viewer and damage to the retina. Therefore, methods for removing short-wavelength light from light which reaches the viewer's eye have been studied. For example, Patent Document 1 discloses a lens which selectively blocks light with wavelengths between 300 nm and 549 nm.

### REFERENCE

### Patent Document

[Patent Document 1] U.S. Pat. No. 4,878,748

### SUMMARY OF THE INVENTION

As electronic devices including display devices have come into widespread use, it has become more often that users keep looking at display devices for a long time. Light emitted from a display device includes short-wavelength light, which increases eye fatigue of a user. Furthermore, such light sometimes damages the retina when the user's eye keeps receiving the light for a long time. Thus, short-wavelength light might do harm to the user's health if a countermeasure such as wearing a lens for removing such light is not taken.

Thus, an object of one embodiment of the present invention is to reduce eye fatigue of a user in long-term use of a display device.

One embodiment of the present invention is a display device including a display unit, a detection unit, and a control unit. The detection unit detects a condition of a user's eye to obtain detected information and transmits the detected information to the control unit. The control unit extracts fatigue information on the user from the detected information and drives the display unit such that a luminance of light with a wavelength shorter than or equal to a predetermined wavelength among light emitted from the display unit is changed on the basis of the fatigue information.

In this structure, the luminance of short-wavelength light is lowered in accordance with the user's fatigue condition detected by the condition of the user's eye. The structure makes it possible to reduce the user's eye fatigue and damage to the retina and prevent harm to the user's health.

In the display device of one embodiment of the present invention, the control unit preferably drives the display unit such that a display refresh rate is changed on the basis of the fatigue information.

In the display device of one embodiment of the present invention, it is preferable that the control unit include a storage unit storing setting information and the control unit drive the display unit on the basis of both the fatigue information and the setting information.

The predetermined wavelength is preferably 420 nm.

A sufficient reduction in display refresh rate makes it possible to prevent flicker in an image displayed on a display portion from being recognized. Flicker in an image increases the user's eye fatigue. Particularly when the user sees short-wavelength light emitted at high frequency, the user's eye is greatly stimulated owing to the high frequency, leading to a further increase in eye fatigue. For this reason, sufficiently reducing refresh rate in addition to lowering the luminance of short-wavelength light enables the user's eye fatigue to be effectively reduced.

In this specification and the like, refresh rate (also referred to as scan frequency or vertical synchronization frequency) is the rate (the number of times per unit time) at which display on a display unit is rewritten.

Another embodiment of the present invention is a program for driving a display device including a display unit, a detection unit, a control unit, and an arithmetic device. The program includes the steps of making the detection unit detect a condition of a user's eye to obtain detected information and transmit the detected information to the control unit; and making the control unit extract fatigue information on the user from the detected information and drive the display unit such that a luminance of light with a wavelength shorter than or equal to a predetermined wavelength among light emitted from the display unit is changed on the basis of the fatigue information. The arithmetic device executes the program.

The program of one embodiment of the present invention preferably further includes the step of making the control unit drive the display unit such that a display refresh rate is changed on the basis of the fatigue information.

Another embodiment of the present invention is a program for driving a display device including a display unit, a detection unit, a control unit, an arithmetic device, and a storage unit. The program includes the steps of making the detection unit detect a condition of a user's eye to obtain detected information and transmit the detected information to the control unit; making the control unit read out setting information stored in the storage unit in advance; and making the control unit extract fatigue information on the user from the detected information and drive the display unit such that a luminance of light with a wavelength shorter than or equal to a predetermined wavelength among light emitted from the display unit is changed on the basis of both the fatigue information and the setting information. The arithmetic device executes the program.

The program of one embodiment of the present invention preferably further includes the step of making the control unit drive the display unit such that a display refresh rate is changed on the basis of both the fatigue information and the setting information.

The predetermined wavelength is preferably 420 nm.

According to one embodiment of the present invention, eye fatigue of a user in long-term use of a display device can be reduced.

### BRIEF DESCRIPTION OF THE DRAWINGS

In the accompanying drawings:

FIG. 1 is a block diagram illustrating a structural example of a display device of one embodiment of the present invention;

FIGS. 2A to 2C each show an example of input-output characteristics of luminance in an operation example of a display device of one embodiment of the present invention;

FIG. 3 shows a flow chart in an operation example of a display device of one embodiment of the present invention;

FIGS. 4A and 4B are a block diagram and a schematic view illustrating a structural example of a display device of one embodiment of the present invention;

FIG. 5 is a block diagram illustrating a structural example of a display device of one embodiment of the present invention;

FIG. 6 is a block diagram illustrating a structural example of a display device of one embodiment of the present invention;

FIGS. 7A and 7B are a block diagram and a circuit diagram illustrating a structural example of a display device of one embodiment of the present invention;

FIG. 8 is a block diagram illustrating a structural example of a display device of one embodiment of the present invention;

FIGS. 9A and 9B illustrate a structural example of a display device of one embodiment of the present invention;

FIG. 10 illustrates a structural example of an arithmetic device which executes a program of one embodiment of the present invention;

FIGS. 11A to 11C each illustrate a structural example of an electronic device including a display device of one embodiment of the present invention;

FIGS. 12A and 12B illustrate examples of display on a display portion in Example;

FIGS. 13A and 13B illustrate examples of display on a display portion in Example;

FIG. 14 shows the measurement results of critical flicker (fusion) frequency in Example; and

FIG. 15 shows the measurement results of near point distance in Example.

### DETAILED DESCRIPTION OF THE INVENTION

Embodiments and an example will be described in detail with reference to the drawings. Note that the present invention is not limited to the following description, and it will be easily understood by those skilled in the art that various changes and modifications can be made without departing from the spirit and scope of the present invention. Therefore, the present invention should not be construed as being limited to the description in the following embodiments and example. Note that in the structures of the invention described below, the same portions or portions having similar functions are denoted by the same reference numerals in different drawings, and description of such portions is not repeated.

Note that in each drawing described in this specification, the size, the layer thickness, or the region of each component is exaggerated for clarity in some cases. Therefore, the embodiments and example of the present invention are not limited to such scales.

### Embodiment 1

In this embodiment, a structural example of a display device of one embodiment of the present invention and an example of a method for driving the display device are described with reference to drawings.

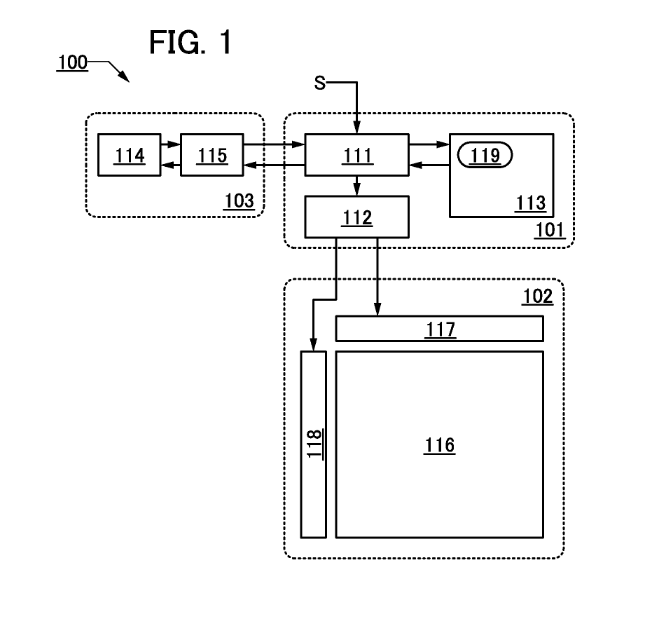

FIG. 1 is a block diagram illustrating a structural example of a display device 100 described as an example in this embodiment.

Although the block diagram attached to this specification shows components classified by their functions in independent blocks, it is difficult to classify actual components according to their functions completely and it is possible for one component to have a plurality of functions.

The display device 100 includes a control unit 101, a display unit 102, and a detection unit 103.

The control unit 101 includes an arithmetic device 111, a controller 112, and a memory device 113. The display unit 102 includes a pixel portion 116, a driver circuit 117, and a driver circuit 118. The detection unit 103 includes a detector 114 and a controller 115.

Driving of the detector 114 included in the detection unit 103 is controlled by the controller 115. The detector 114 can detect the conditions of a user's eye and output information (also referred to as detected information) on the conditions of the eye to the controller 115.

Conditions of a user's eye include movement of the eyeball, the color and the shape of components (e.g., the sclera, the iris, and the pupil) of the eyeball, and movement of the eyelid.

A camera can be typically used as the detector 114. In that case, an image of the user's eyeball is taken by the camera and output to the controller 115 as detected information.

Alternatively, the detector 114 may include a light source emitting infrared light and a light receiving portion detecting infrared light reflected from the user's eyeball. Use of infrared light makes it possible to precisely detect the conditions of the user's eye without putting strain on the user.

The controller 115 drives the detector 114 in accordance with control signals input from the arithmetic device 111 in the control unit 101. Further, the controller 115 outputs the detected information input from the detector 114 to the arithmetic device 111 in the control unit 101.

The controller 112, operation of which is controlled by the arithmetic device 111, in the control unit 101 outputs driving signals including a video signal, a synchronization signal, and the like to the driver circuit 117 and the driver circuit 118.

Note that a D/A converter may be provided between the arithmetic device 111 and the controller 112. Alternatively, a D/A converter may be provided between the controller 112 and the driver circuit 117 or the driver circuit 118.

Pixels in the pixel portion 116 are driven by the driver circuit 117 and the driver circuit 118, whereby an image can be displayed in the pixel portion 116.

A video signal S is input to the arithmetic device 111. The video signal S, which is a compressed or encoded signal, can be decoded by the arithmetic device 111. The arithmetic device 111 may also have a function of performing pixel interpolation in accordance with up-conversion of resolution, performing frame interpolation in accordance with up-conversion of frame frequency, or performing image processing such as noise removal, grayscale conversion, or tone correction.

The arithmetic device 111 can also control the operation of the controller 112, which drives the display unit 102. For example, the arithmetic device 111 outputs the decoded video signal, a synchronization signal, and the like to the controller 112, thereby controlling the operation of the controller 112. Moreover, the arithmetic device 111 can read out information stored in the memory device 113 or write information into the memory device 113.

Here, the arithmetic device 111 extracts information on the user's fatigue from the detected information input from the detection unit 103, and controls the operation of the controller 112 such that the display unit 102 is driven by the controller 112 in such a manner that the luminance of light with wavelengths shorter than or equal to a specific wavelength among light emitted from the display unit 102 is changed on the basis of the fatigue information.

An example of a method for changing the luminance of light emitted from the display unit 102 is to output, as a video signal output to the controller 112, a signal which is obtained by correcting the output level of a color corresponding to wavelengths shorter than or equal to a specific wavelength included in the video signal S.

For example, when the video signal S includes luminance information on three colors of red (R), green (G), and blue (B), the luminance of light in a short wavelength range can be changed by a correction such that the output luminance of B is changed. In that case, the correction may be such that luminance information on B is uniformly changed, luminances higher than a predetermined luminance in the luminance information on B are not output, or contrast is changed.

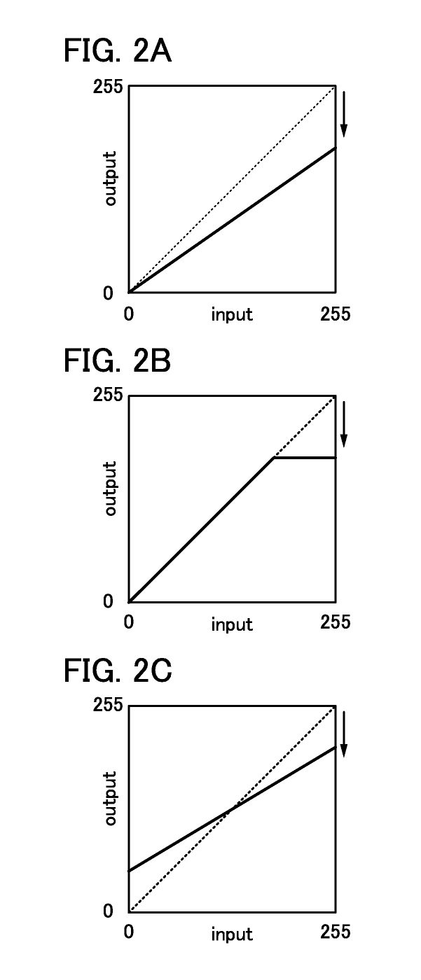

FIGS. 2A to 2C show examples of input-output characteristics of luminance. In each example, the video signal S is corrected such that luminance is lowered. Here, luminance is divided into 256 levels.

In FIG. 2A, the video signal S is corrected such that the slope of output luminance versus input luminance is made gentler. In this correction, luminance can be uniformly lowered from the lower luminance side through the higher luminance side. In FIG. 2B, the video signal S is corrected such that luminances higher than a predetermined luminance are not output. In this correction, luminances on the lower luminance side with respect to the predetermined luminance are not changed and not accompanied by change in color tone; accordingly, display can be made natural. In FIG. 2C, the video signal S is corrected such that the slope of output luminance versus input luminance is made gentler as in FIG. 2A. FIG. 2C differs from FIG. 2A in that luminances on the higher luminance side are lowered and luminances on the lower luminance side are raised. This correction is a correction such that display contrast is lowered.

At least a signal for a color corresponding to the shortest wavelength (e.g., B) included in the video signal S is corrected in any of the above manners. It is also possible to correct signals for all colors (e.g., R, G and B) included in the video signal S, in which case change in color tone of display accompanying the correction can be made natural.

It is preferable to change the luminance of light with wavelengths longer than or equal to 280 nm and shorter than or equal to 500 nm, preferably longer than or equal to 280 nm and shorter than or equal to 420 nm by the correction.

In display devices such as liquid crystal display devices, a glass substrate is used for the display surface side in many cases; thus, a user sees light which has passed through a glass material. Many glass materials have extremely low transmittance of light with wavelengths shorter than or equal to 280 nm; accordingly, light with wavelengths shorter than or equal to 280 nm hardly reaches an eye of the user of the display device.

Light with wavelengths shorter than or equal to 500 nm, particularly light with wavelengths shorter than or equal to 420 nm has high energy and thus partly reaches the retina of an eye without being absorbed by the cornea or the lens, thereby causing eye fatigue. Moreover, light with such wavelengths might have long-term effects on the retina (e.g., age-related macular degeneration). Further, exposure to the light until midnight might bring about adverse effects on the circadian rhythm. Those who have light-colored eyes are particularly subject to the effect of short-wavelength light because of low proportion of melanin pigments, which absorb such light, in the iris. In addition, short-wavelength light tends to be scattered and thus causes a character or an image displayed in a pixel portion to appear blurred, for example. In focusing the eye on the blurred character or image, the ciliary muscle, which contracts the pupil, is stimulated and eye fatigue is caused. For the above reasons, lowering the luminance of light with such wavelengths leads to effective reduction of eye fatigue of a user.

Next, fatigue information which the arithmetic device 111 extracts is described. Examples of information on the user's fatigue are the length of screen gazing time, the number of times of blinking per unit time, and the like. In addition, the amplitude or the frequency of nystagmus, the degree of inflammation of the eyeball, the area of the pupil, and the rate of convulsions of the eyelid or the like can be used as fatigue information. Other examples of fatigue information are actions which are physiologically likely to be taken owing to fatigue, for example, the user closing one's eyelids for a long time (e.g., one second or longer) or the user pressing one's eye area with a finger or the like, and the rate of such actions. The arithmetic device 111 extracts, as data, such fatigue information included in the detected information.

A lookup table (LUT) 119 is stored in the memory device 113 in advance. The LUT 119 has a data structure which defines correspondence between data of fatigue information and correction data for changing the luminance of light with wavelengths shorter than or equal to a specific wavelength emitted from the display unit 102. Results of statistical calculation based on data which is obtained by performing a test on a plurality of testees can be used for the LUT 119.

As the correction data included in the LUT 119, for example, a parameter which defines input-output characteristics of luminance shown in FIGS. 2A to 2C can be used.

The arithmetic device 111 compares the data of extracted fatigue information with the LUT 119 and obtains correction data corresponding to the fatigue information. Then, the arithmetic device 111 controls the controller 112 in such a manner that the luminance of light with wavelengths shorter than or equal to a specific wavelength emitted from the display unit 102 is changed on the basis of the obtained correction data.

Here, the fatigue information extracted by the arithmetic device 111 is preferably divided into levels (fatigue levels) in accordance with the user's fatigue condition. Luminance is corrected on the basis of the correction data corresponding to the fatigue level. For example, the degree of lowering luminance is varied depending on whether the user's fatigue is slight or serious.

Moreover, the correction data may be updated stepwise when the user's fatigue continues for a certain period. For example, the degree of lowering luminance is increased stepwise every certain period as the state where the user's fatigue is not relieved continues.

In this manner, the degree of correction is increased stepwise in accordance with the fatigue level or the length of the period during which the fatigue continues; such operation makes it possible to relieve accumulation of the user's fatigue and further reduce the fatigue even in long-term use of the display device.

Note that when the user's fatigue is sensed, in addition to the correction of luminance, display for notifying the user's fatigue may be performed by the display unit. Such display on the display unit can encourage the user to stop using the display device, for example, thereby preventing accumulation of eye fatigue.

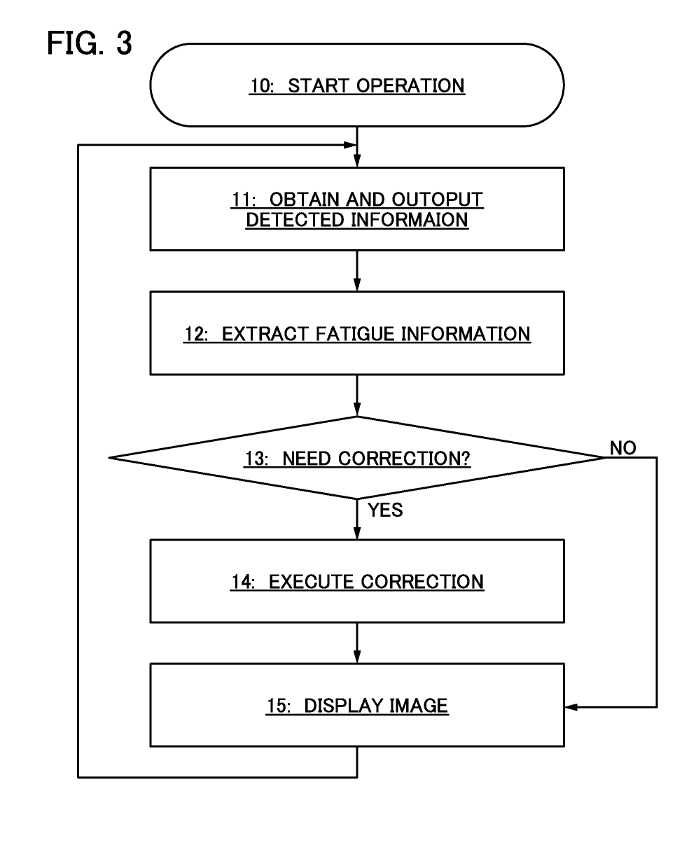

Next, an example of a procedure of the operation of the display device 100 is described. FIG. 3 is a flow chart showing the operation of the display device 100.

In Step 10, the display device 100 starts to operate.

In Step 11, the detector 114 obtains detected information and outputs the detected information to the arithmetic device 111 through the controller 115.

In Step 12, the arithmetic device 111 extracts fatigue information as data from the detected information.

In Step 13, the arithmetic device 111 compares the data of fatigue information with the LUT 119 stored in the memory device 113 and, when correction data corresponding to data of the fatigue information exists in the LUT 119, obtains the correction data. On the other hand, when correction data corresponding to the data of fatigue information does not exist (correction is not necessary), the procedure moves on to Step 15 without obtaining correction data.

In Step 14, the arithmetic device 111 corrects the input video signal S on the basis of the correction data to generate a corrected video signal. Here, the arithmetic device 111 can also perform the above-described image processing on the video signal S.

In Step 15, the arithmetic device 111 outputs driving signals including the generated video signal to the controller 112. The controller 112 drives the driver circuit 117 and the driver circuit 118 in accordance with the driving signals; thus, an image is displayed in the pixel portion 116.

After Step 15, the procedure returns to Step 11 and the operation is repeated.

The above is the description of the operation example of the display device 100.

In the display device 100 described in this embodiment, the luminance of short-wavelength light is lowered in accordance with the user's fatigue condition detected by the condition of the user's eye. This structure makes it possible to reduce the user's eye fatigue and damage to the retina and prevent harm to the user's health.

### Modification Example 1

Described below is a structural example of a display device which is partly different from the display device 100 described above. Note that portions similar to those described above are not described in some cases.

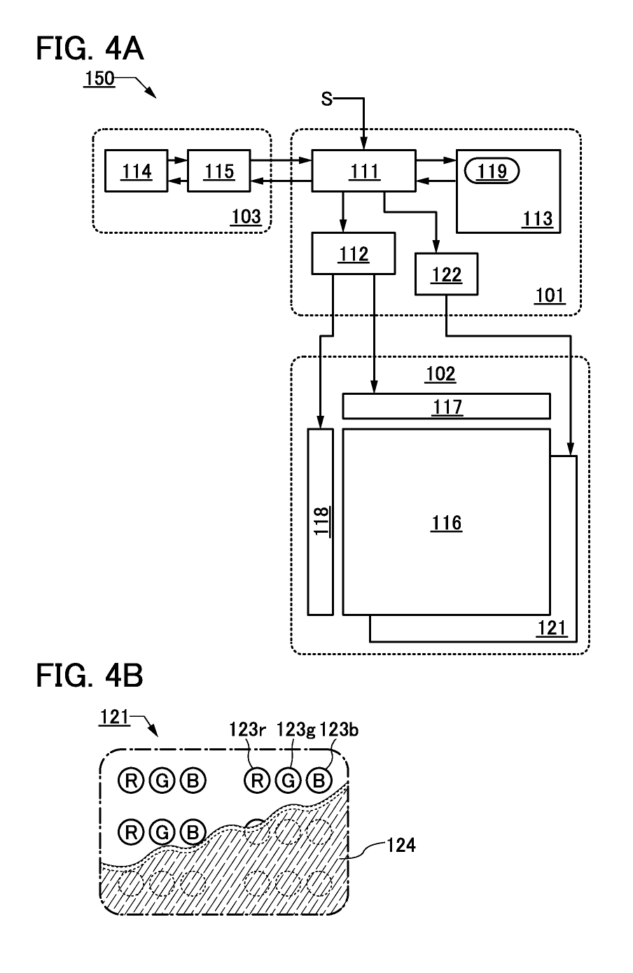

A display device 150 illustrated in FIG. 4A is an example of a liquid crystal display device. The display device 150 differs from the display device 100 in that the display unit 102 includes a backlight 121 and in that the control unit 101 includes a controller 122.

The backlight 121 is preferably a backlight capable of emitting light of two or more different colors, the luminances of which can be separately controlled. Here, the backlight 121 preferably emits light of three colors, red (R), green (G), and blue (B), or more.

Alternatively, it is possible that only light of colors whose luminances are to be changed can be separately controlled. For example, the backlight 121 may emit blue (B) light and light of two colors (e.g., red (R) and green (G)) which serve as the complementary color of blue, and the luminance of blue light and the luminance of light of the two colors can be separately controlled.

FIG. 4B is a schematic view illustrating an example of the structure of the backlight 121. The backlight 121 includes a plurality of light sources 123r which emit red light, a plurality of light sources 123g which emit green light, and a plurality of light sources 123b which emit blue light. Further, a diffusion plate 124 is provided to overlap with the light sources 123r, 123g, and 123b.

The light sources 123r, 123g, and 123b emit light with respective predetermined luminances, whereby white light can be emitted from the backlight 121. Further, light of a variety of colors can be emitted by changing the respective luminances of the light sources 123r, 123g, and 123b.

As each of the light sources 123r, 123g, and 123b, a light-emitting element such as a light-emitting diode (LED), an organic EL element, or an inorganic EL element can be used, for example.

The diffusion plate 124, which is provided in order to diffuse light emitted from the light sources, enables the backlight 121 to provide plane light emission with improved luminance distribution.

The controller 122 included in the control unit 101 can control driving of the backlight 121. Specifically, the controller 122 can separately control the luminances of light of a plurality of colors emitted by the backlight 121. The operation of the controller 122 is controlled by the arithmetic device 111.

The arithmetic device 111 controls the operation of the controller 122 such that the luminance of light with wavelengths shorter than or equal to a specific wavelength among light emitted from the backlight 121 is changed on the basis of the fatigue information extracted from the detected information. For example, the arithmetic device 111 controls the operation of the controller 122 in such a manner that, when the user's fatigue is sensed, the luminance of light of an emission color (e.g., B) corresponding to the shortest wavelength among light emitted from the backlight 121 is lowered.

With such a structure, the luminance of light with wavelengths shorter than or equal to a specific wavelength emitted from the display unit 102 can be controlled more easily.

Note that the arithmetic device 111 may perform the correction of the video signal S concurrently with the control of driving of the backlight 121.

The above is the description of this modification example.

### Modification Example 2

Described below is another structural example of a display device which is partly different from the display device 100 described above. Note that portions similar to those described above are not described in some cases.

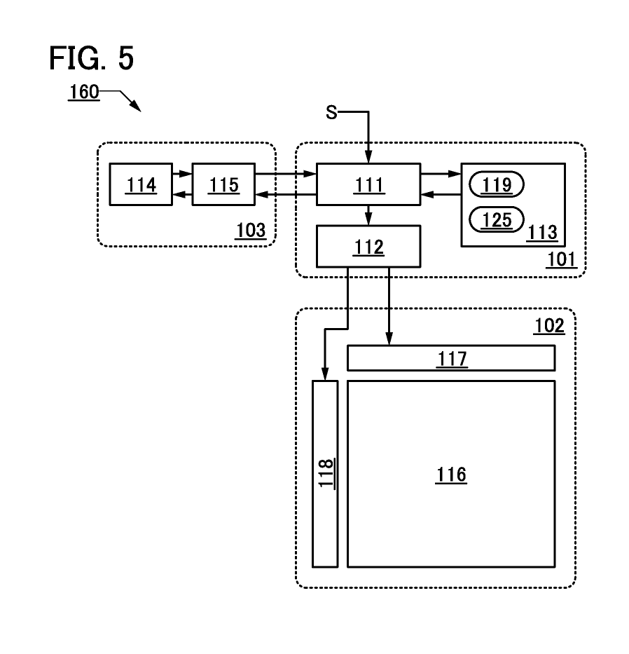

A display device 160 illustrated in FIG. 5 differs from the display device 100 in that setting information 125 is stored in the memory device 113.

The setting information 125 includes information for determining the processing which the arithmetic device 111 performs. For example, it is determined by the information whether or not to perform processing for changing, on the basis of the user's fatigue condition, the luminance of light emitted from the display unit 102. The setting information 125 may also include a parameter for setting the degree of changing luminance, specifying a color whose luminance of light is to be changed, setting the rate of detecting the fatigue condition, setting the threshold value in determining the fatigue condition, or the like.

It is preferable to allow a user to freely change the information included in the setting information 125. For example, the contents of the setting information 125 stored in the memory device 113 can be viewed by being displayed as an image on the display unit 102, and the user can change the contents of the setting information with an input unit which is not shown.

The arithmetic device 111 can read out the setting information 125 stored in the memory device 113. For example, the setting information 125 may be read out at startup of the display device 160 or when being updated.

The arithmetic device 111 executes processing on the basis of both the setting information 125 and the fatigue information extracted from the detected information.

In this manner, a user can set the conditions or the like for the processing by the arithmetic device 111 in advance; thus, change in luminance of light emitted from the display unit 102 can be set within a range which is acceptable to the user, so that eye fatigue can be effectively reduced with the user feeling no stress.

Note that the display device 160 may include the backlight 121 and the controller 122 described in Modification Example 1, in which case the arithmetic device 111 can change the luminance of light emitted from the backlight 121, on the basis of the setting information 125.

The above is the description of this modification example.

### Modification Example 3

In this modification example, a display device capable of driving in a manner different from the above is described. Note that portions similar to those described above are not described in some cases.

In the display device described in this modification example, the refresh rate (also referred to as scan frequency or vertical synchronization frequency) of display on the display unit 102 can be varied on the basis of fatigue information extracted from the detected information. Specifically, the display device can be switched between a first mode in which the display device operates at a predetermined refresh rate and a second mode in which the display device operates at a refresh rate lower than that in the first mode.

Flicker which accompanies switching of display might cause eye fatigue of a user. In view of this, when the user's fatigue is sensed, display is performed at extremely low refresh rate; thus, it is possible to reduce flicker which accompanies switching of display, thereby relieving accumulation of the user's fatigue and reducing the fatigue.

The refresh rate in the first mode can be higher than or equal to 30 Hz, preferably higher than or equal to 60 Hz and lower than 960 Hz. With a refresh rate such that change in images which occurs each time signals are rewritten is not recognized by the user, a smooth moving image can be displayed.

The refresh rate in the second mode can be higher than or equal to 1.16×10⁻⁵ Hz (about once per day) and lower than or equal to 10 Hz, preferably higher than or equal to 2.78×10⁻⁴ Hz (about once per hour) and lower than or equal to 1 Hz. Such extremely low refresh rate enables display substantially without flicker.

Note that the refresh rate is the same as the frame rate in the case where images are displayed by a progressive method, whereas the refresh rate is different from the frame rate in the case where images are displayed by an interlace method.

When a still image is displayed, the second mode is employed, which enables display without flicker. When a moving image is displayed, the display device is switched from the second mode to the first mode; thus, a smooth moving image can be displayed. As described above, when the user's fatigue is sensed, the display device is driven with the mode being switched between the first mode and the second mode depending on the displayed image, so that eye fatigue can be effectively reduced with the user feeling no stress. Note that even when the user's fatigue is not sensed or the fatigue is not serious, eye fatigue can be prevented or effectively reduced by driving with the two modes.

Here, in the second mode, image rewrite operation is preferably performed concurrently with the user's blinking. When an image is rewritten concurrently with the user's blinking, flicker which accompanies the rewriting is not recognized by the user; thus, eye fatigue can be more effectively reduced.

For example, in the display device 100 illustrated in FIG. 1, the above-described operation can be achieved in the following manner: the arithmetic device 111 senses from an image of the user's eyeball taken by the detector 114 that the user has started blinking, and drives the controller 112 to make the controller 112 perform the operation of rewriting an image displayed in the pixel portion 116. The timing at which the user starts blinking can be determined by detecting movement of the user's eyelid, for example.

A specific structure of a display device capable of driving at such an extremely low refresh rate is described in Embodiment 2.

Note that the refresh rate in the second mode may be higher than that in the first mode. Rewriting an image at an extremely high refresh rate can reduce flicker recognized by the user, thus preventing accumulation of eye fatigue. In that case, the refresh rate in the first mode can be higher than or equal to 30 Hz and lower than 75 Hz, and the refresh rate in the second mode can be higher than or equal to 75 Hz and lower than 960 Hz, for example.

The above is the description of this modification example.

Here, an image which is displayed is described. Rapid switching of display might cause eye fatigue which a user is not aware of. Examples of switching of display include switching between different scenes and switching between different still images.

Therefore, it is preferable to perform display such that, in switching between non-consecutive images, the images are switched smoothly (quietly) and naturally instead of being switched momentarily. For example, a technique such as fade-in or fade-out is preferably used when display is switched between a first image and a second image which are non-consecutive images. It is particularly preferable to switch display in such a manner that the two images temporarily overlap with each other so that the second image fades in concurrently with fade-out of the first image (this technique is also referred to as cross-fade).

This embodiment can be combined with any of the other embodiments disclosed in this specification as appropriate.

### Embodiment 2

In this embodiment, examples of a semiconductor device with a display function (also referred to as display device) in which refresh rate can be varied and a method for driving the display device are described with reference to drawings.

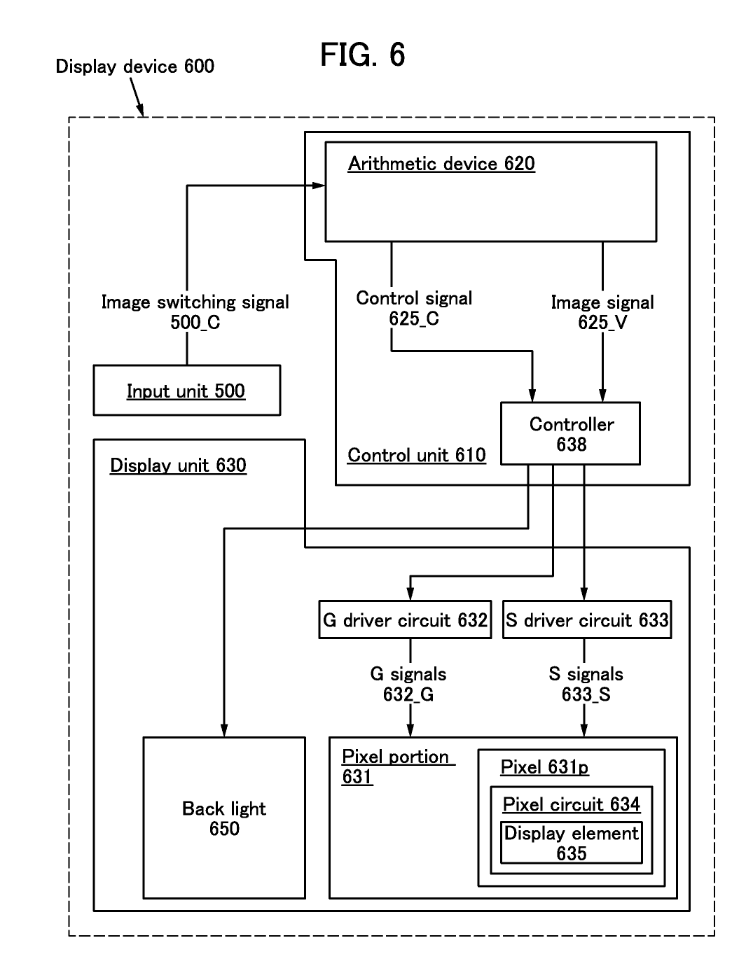

FIG. 6 is a block diagram illustrating a structure of a display device described as an example in this embodiment.

### <1. Structure of Display Device>

A display device 600 illustrated in FIG. 6 includes at least a control unit 610 and a display unit 630. The display unit 630 includes a pixel portion 631, pixel circuits 634 which hold first driving signals (also referred to as S signals) 633_S input and include display elements 635 displaying an image in the pixel portion 631 in accordance with the S signals 633_S, a first driver circuit (also referred to as S driver circuit) 633 which outputs the S signals 633_S to the pixel circuits 634, and a second driver circuit (also referred to as G driver circuit) 632 which outputs second driving signals (also referred to as G signals) 632_G for selecting the pixel circuits 634 to the pixel circuits 634.

The G driver circuit 632 has a first mode in which the G signals 632_G are output to the pixels at a rate of higher than or equal to 30 times per second, preferably higher than or equal to 60 times per second and lower than 960 times per second, and a second mode in which the G signals 632_G are output to the pixels at a rate of higher than or equal to once per day and lower than 0.1 times per second, preferably higher than or equal to once per hour and lower than once per second.

Note that the G driver circuit 632 is switched between the first mode and the second mode in response to a mode switching signal(s) which is/are input.

The pixel circuit 634 is provided in a pixel 631p. A plurality of pixels 631p is provided in the pixel portion 631 in the display unit 630.

The control unit 610 includes an arithmetic device 620. The arithmetic device 620 outputs control signals 625_C and image signals 625_V.

The control unit 610 includes a controller 638, which controls the S driver circuit 633 and the G driver circuit 632.

In the case where a liquid crystal element is used as the display element 635, the display unit 630 is provided with a backlight 650. The backlight 650 supplies light to the pixel portion 631 including liquid crystal elements.

In the display device 600, the rate of selecting one pixel circuit from the plurality of pixel circuits 634 in the pixel portion 631 can be changed by the G signals 632_G output from the G driver circuit 632. Consequently, a display device with a display function which is less likely to cause eye fatigue of a user can be provided as the display device 600.

Although the block diagram attached to this specification shows components classified by their functions in independent blocks, it is difficult to classify actual components according to their functions completely and it is possible for one component to have a plurality of functions.

In this specification, the terms “source” and “drain” of a transistor interchange with each other depending on the polarity of the transistor or the levels of potentials applied to the terminals. In general, in an n-channel transistor, a terminal to which a lower potential is applied is called a source, and a terminal to which a higher potential is applied is called a drain. Further, in a p-channel transistor, a terminal to which a lower potential is applied is called a drain, and a terminal to which a higher potential is applied is called a source. In this specification, although connection relation of the transistor is described assuming that the source and the drain are fixed in some cases for convenience, actually, the names of the source and the drain interchange with each other depending on the relation of the potentials.

Note that in this specification, a “source” of a transistor means a source region that is part of a semiconductor film functioning as an active layer or a source electrode connected to the semiconductor film. Similarly, a “drain” of the transistor means a drain region that is part of the semiconductor film or a drain electrode connected to the semiconductor film. A “gate” means a gate electrode.

Note that in this specification, a state in which transistors are connected to each other in series means, for example, a state in which only one of a source and a drain of a first transistor is connected to only one of a source and a drain of a second transistor. In addition, a state in which transistors are connected to each other in parallel means a state in which one of a source and a drain of a first transistor is connected to one of a source and a drain of a second transistor and the other of the source and the drain of the first transistor is connected to the other of the source and the drain of the second transistor.

In this specification, the term “connection” means electrical connection and corresponds to a state where current, voltage, or a potential can be supplied or transmitted. Accordingly, a connection state means not only a state of direct connection but also a state of indirect connection through a circuit element such as a wiring, a resistor, a diode, or a transistor so that current, voltage, or a potential can be supplied or transmitted.

In this specification, even when different components are connected to each other in a circuit diagram, there is actually a case where one conductive film has functions of a plurality of components such as a case where part of a wiring serves as an electrode. The term “connection” also means such a case where one conductive film has functions of a plurality of components.

Elements included in the display device of one embodiment of the present invention will be described below.

### <2-1. Display Unit>

The display unit 630 includes the pixel portion 631 including the display element 635 in each pixel and driver circuits such as the S driver circuit 633 and the G driver circuit 632. The pixel portion 631 includes the plurality of pixels 631p each provided with the display element 635 (see FIG. 6).

The image signals 625_V that are input to the display unit 630 are supplied to the S driver circuit 633. In addition, power supply potentials and the control signals 625_C are supplied to the S driver circuit 633 and the G driver circuit 632.

Note that the control signals 625_C include an S driver circuit start pulse signal SP, an S driver circuit clock signal CK, and a latch signal LP that control the operation of the S driver circuit 633; a G driver circuit start pulse SP, a G driver circuit clock signal CK, and a pulse width control signal PWC that control the operation of the G driver circuit 632; and the like.

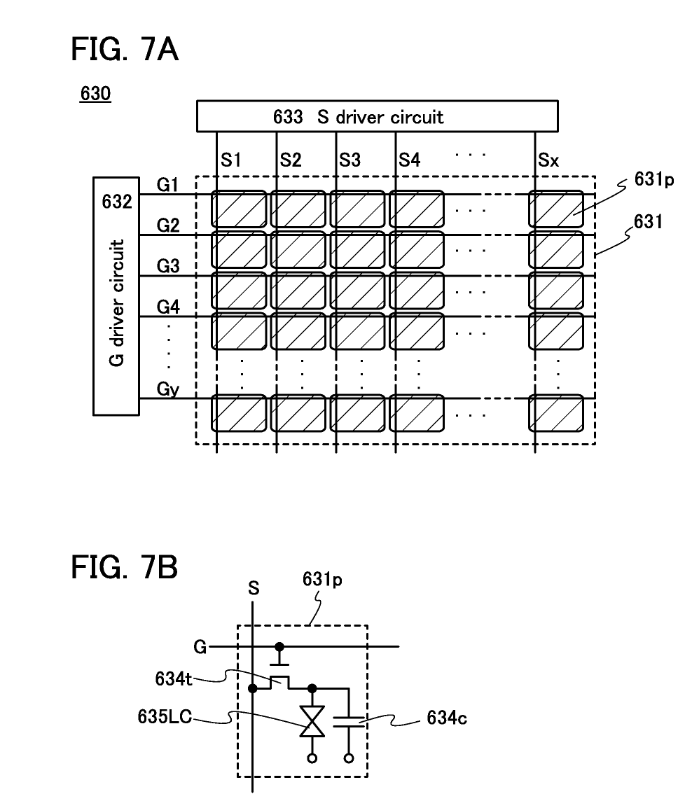

FIG. 7A illustrates an example of a structure of the display unit 630.

In the display unit 630 in FIG. 7A, the plurality of pixels 631p, a plurality of scan lines G for selecting the pixels 631p row by row, and a plurality of signal lines S for supplying the S signals 633_S generated from the image signals 625_V to the selected pixels 631p are provided in the pixel portion 631.

The input of the G signals 632_G to the scan lines G is controlled by the G driver circuit 632. The input of the S signals 633_S to the signal lines S is controlled by the S driver circuit 633. Each of the plurality of pixels 631p is connected to at least one of the scan lines G and at least one of the signal lines S.

Note that the kinds and number of the wirings in the pixel portion 631 can be determined by the structure, number, and position of the pixels 631p. Specifically, in the pixel portion 631 illustrated in FIG. 7A, the pixels 631p are arranged in a matrix of x columns and y rows, and the signal lines S1 to Sx and the scan lines G1 to Gy are provided in the pixel portion 631.

### <2-1-1. Pixel>

The pixel 631p includes the display element 635 and the pixel circuit 634 including the display element 635.

### <2-1-2. Pixel Circuit>

In this embodiment, a structure in which a liquid crystal element 635LC is used as the display element 635 is illustrated as an example of the pixel circuit 634 in FIG. 7B.

The pixel circuit 634 includes a transistor 634t for controlling supply of the S signal 633_S to the liquid crystal element 635LC. An example of connection relation between the transistor 634t and the liquid crystal element 635LC will be described.

A gate of the transistor 634t is connected to any one of the scan lines G1 to Gy. One of a source and a drain of the transistor 634t is connected to any one of the signal lines S1 to Sx. The other of the source and the drain of the transistor 634t is connected to a first electrode of the liquid crystal element 635LC.

Note that the pixel 631p may further include a capacitor 634c for holding voltage between the first electrode and a second electrode of the liquid crystal element 635LC and another circuit element such as a transistor, a diode, a resistor, a capacitor, or an inductor as needed.

In the pixel 631p illustrated in FIG. 7B, one transistor 634t is used as a switching element controlling input of the S signal 633_S to the pixel 631p; however, a plurality of transistors functioning as one switching element may be used in the pixel 631p. In the case where a plurality of transistors functions as one switching element, the plurality of transistors may be connected to each other in parallel, in series, or in combination of parallel connection and series connection.

Note that the size of the capacitor 634c can be adjusted as appropriate. For example, in the case where the S signal 633_S is held for a relatively long period (specifically, 1/60 sec or more) in the second mode, the capacitor 634c with an appropriate size is provided. It is also possible to adjust the capacitance of the pixel circuit 634 with use of a structure other than the capacitor 634c. For example, the first electrode and the second electrode of the liquid crystal element 635LC may be overlapped with each other to substantially form a capacitor.

Note that the structure of the pixel circuit 634 can be selected in accordance with the kind or the driving method of the display element 635.

<2-1-2a. Display Element>

The liquid crystal element 635LC includes the first electrode, the second electrode, and a liquid crystal layer including a liquid crystal material to which the voltage between the first electrode and the second electrode is applied. In the liquid crystal element 635LC, the alignment of liquid crystal molecules is changed in accordance with the level of voltage applied between the first electrode and the second electrode, so that the transmittance is changed. Accordingly, the transmittance of the display element 635 is controlled by the potential of the S signal 633_S; thus, gradation can be expressed.

Note that, besides the liquid crystal element 635LC, any of a variety of display elements such as an OLED element generating luminescence (electroluminescence) when an electric field is applied thereto and electronic ink utilizing electrophoresis can be used as the display element 635.

<2-1-2b. Transistor>

The transistor 634t controls whether to apply the potential of the signal line S to the first electrode of the display element 635. A predetermined reference potential Vcom is applied to the second electrode of the display element 635.

Note that a transistor including an oxide semiconductor can be suitably used for a display device which can be driven by the method for driving a display device of one embodiment of the present invention. Details of the transistor including an oxide semiconductor are described in Embodiment 3 and Embodiment 4.

### <2-2. Controller>

The controller 638 transmits the image signals 625_V generated by the arithmetic device 620 to the display unit 630 (see FIG. 6).

The controller 638 also has functions of generating control signals such as a start pulse signal SP, a latch signal LP, and a pulse width control signal PWC by using a synchronization signal such as a vertical synchronization signal or a horizontal synchronization signal and supplying the control signals to the display unit 630. A control signal such as a clock signal CK is also supplied to the display unit 630.

Further, the controller 638 may be provided with an inversion control circuit to have a function of inverting the polarity of the image signal 625_V at a timing notified by the inversion control circuit. Specifically, the polarity of the image signal 625_V may be inverted in the controller 638, or may be inverted in the display unit 630 in accordance with an instruction from the controller 638.

The inversion control circuit has a function of determining timing of inverting the polarity of the image signal 625_V by using a synchronization signal. For example, the inversion control circuit includes a counter and a signal generation circuit.

The counter has a function of counting the number of frame periods by using the pulse of a horizontal synchronization signal.

The signal generation circuit has a function of notifying timing of inverting the polarity of the image signal 625_V to the controller 638 so that the polarity of the image signal 625_V is inverted every plural consecutive frame periods by using information on the number of frame periods that is obtained in the counter.

### <2-3. Arithmetic Device>

The arithmetic device 620 generates the image signals 625_V to be input to the display unit 630. Note that the image signals 625_V may be directly input to the controller 638.

Further, the following structure may be employed: the arithmetic device 620 outputs the control signals 625_C including a mode switching signal(s), and the mode switching signal(s) included in the control signals 625_C is/are input to the G driver circuit 632.

For example, the arithmetic device 620 can output the control signals 625_C including a mode switching signal(s) in accordance with image switching signals 500_C input from an input unit 500.

When the image switching signals 500_C are input from the input unit 500, a mode switching signal is input to the G driver circuit 632 in the second mode through the controller 638, so that the G driver circuit 632 is switched from the second mode to the first mode and outputs the G signals 632_G at least once, then being switched to the second mode.

Alternatively, the following structure may be employed: the arithmetic device 620 determines whether an image based on the image signals 625_V to be output to the display unit 630 is a moving image or a still image, and the arithmetic device 620 outputs a switching signal selecting the first mode when the image based on the image signals 625_V is a moving image and outputs a switching signal selecting the second mode when the image based on the image signals 625_V is a still image.

An example of a method for determining whether the image based on the image signals is a moving image or a still image is as follows. Signals for one frame included in the image signals 625_V are compared with signals for the pervious frame and signals for the next frame, whereby differences are obtained. It is determined that the image is a moving image when the differences are each greater than a predetermined difference, and it is determined that the image is a still image in other cases.

Further, a structure may be employed in which when the G driver circuit 632 is switched from the second mode to the first mode, the G driver circuit 632 outputs the G signals 632_G predetermined times, which is once or more times, then being switched to the second mode.

### <2-4. Backlight>

A plurality of light sources is provided in the backlight 650. The controller 638 controls driving of the light sources in the backlight 650. A control circuit controlling driving of the light sources may be provided between the controller 638 and the backlight 650.

The light source in the backlight 650 can be a cold cathode fluorescent lamp, a light-emitting diode (LED), an OLED element generating luminescence (electroluminescence) when an electric field is applied thereto, or the like.

In particular, the intensity of blue light emitted by the light source is preferably weakened compared to that of light of any other color. Blue light included in light emitted by the light source reaches the retina of the eye without being absorbed by the cornea or the lens. Accordingly, weakening the intensity of blue light emitted by the light source compared to that of light of any other color makes it possible to reduce long-term effects of blue light on the retina (e.g., age-related macular degeneration), adverse effects of exposure to blue light until midnight on the circadian rhythm, and the like.

<3-1. Method for Writing S Signals into Pixel Portion>

An example of a method for writing the S signals 633_S into the pixel portion 631 in FIG. 7A is described. Specifically, the method described here is a method for writing the S signal 633_S into each pixel 631p including the pixel circuit illustrated in FIG. 7B in the pixel portion 631.

<Writing Signals into Pixel Portion>

In a first frame period, the scan line G1 is selected by input of the G signal 632_G with a pulse to the scan line G1. In each of the plurality of pixels 631p connected to the selected scan line G1, the transistor 634t is turned on.

When the transistors 634t are on (in one line period), the potentials of the S signals 633_S generated from the image signals 625_V are applied to the signal lines 51 to Sx. Through each of the transistors 634t that are on, charge corresponding to the potential of the S signal 633_S is accumulated in the capacitor 634c and the potential of the S signal 633_S is applied to the first electrode of the liquid crystal element 635LC.

In a period during which the scan line G1 is selected in the first frame period, the S signals 633_S having a positive polarity are sequentially input to all the signal lines S1 to Sx. Thus, the S signals 633_S having a positive polarity are input to first electrodes G1S1 to G1Sx in the pixels 631p that are connected to the scan line G1 and the signal lines S1 to Sx. The transmittance of the liquid crystal element 635LC is controlled by the potential of the S signal 633_S; thus, gradation is expressed by the pixels.

Similarly, the scan lines G2 to Gy are sequentially selected, and the pixels 631p connected to the scan lines G2 to Gy are sequentially subjected to the same operation as that performed while the scan line G1 is selected. Through the above operations, an image for the first frame can be displayed in the pixel portion 631.

Note that in one embodiment of the present invention, the scan lines G1 to Gy are not necessarily selected sequentially.

It is possible to employ dot sequential driving in which the S signals 633_S are sequentially input to the signal lines 51 to Sx from the S driver circuit 633 or line sequential driving in which the S signals 633_S are input all at once. Alternatively, a driving method in which the S signals 633_S are sequentially input to every plural signal lines S may be employed.

In addition, the method for selecting the scan lines G is not limited to progressive scan; interlaced scan may be employed for selecting the scan lines G.

In given one frame period, the polarities of the S signals 633_S input to all the signal lines may be the same, or the polarities of the S signals 633_S to be input to the pixels may be inverted signal line by signal line.

<Writing Signals into Pixel Portion Divided into Plural Regions>

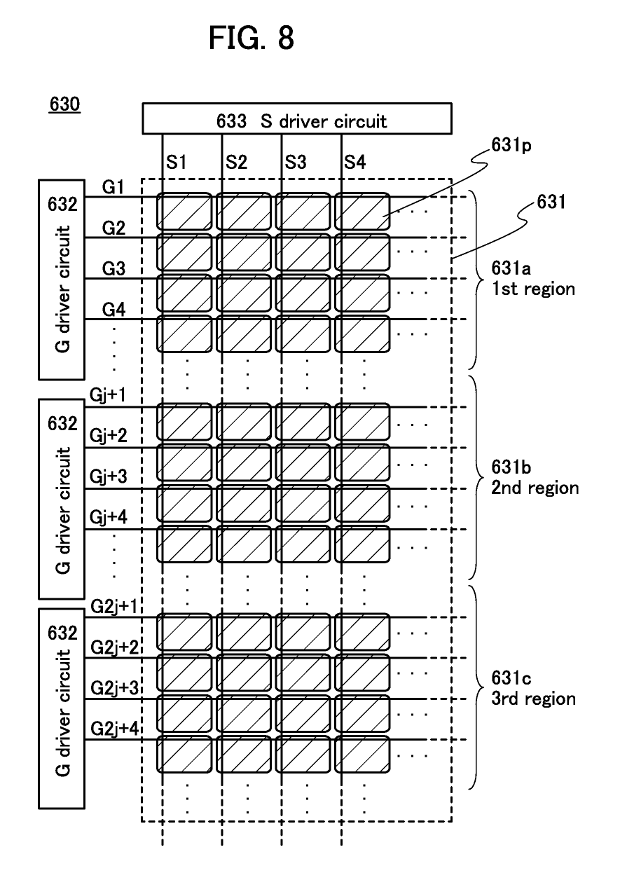

FIG. 8 illustrates a modification example of the structure of the display unit 630.

In the display unit 630 in FIG. 8, the plurality of pixels 631p, the plurality of scan lines G for selecting the pixels 631p row by row, and the plurality of signal lines S for supplying the S signals 633_S to the selected pixels 631p are provided in the pixel portion 631 divided into plural regions (specifically, a first region 631a, a second region 631b, and a third region 631c).

The input of the G signals 632_G to the scan lines G in each region is controlled by the corresponding G driver circuit 632. The input of the S signals 633_S to the signal lines S is controlled by the S driver circuit 633. Each of the plurality of pixels 631p is connected to at least one of the scan lines G and at least one of the signal lines S.

Such a structure allows the pixel portion 631 to be divided into separately driven regions.

For example, the following operation is possible: a touch panel is used as the input unit 500, and when information is input from the touch panel, coordinates specifying a region to which the information is to be input are obtained, and the G driver circuit 632 driving the region corresponding to the coordinates operates in the first mode and the G driver circuit 632 driving the other region operates in the second mode. Thus, it is possible to stop the operation of the G driver circuit for a region where information has not been input from the touch panel, that is, a region where rewriting of a displayed image is not necessary.

### <3-2. G Driver Circuit in First Mode and Second Mode>

The S signal 633_S is input to the pixel circuit 634 to which the G signal 632_G output by the G driver circuit 632 is input. In a period during which the G signal 632_G is not input, the pixel circuit 634 holds the potential of the S signal 633_S. In other words, the pixel circuit 634 holds a state where the potential of the S signal 633_S is written in.

The pixel circuit 634 into which display data is written maintains a display state corresponding to the S signal 633_S. Note that to maintain a display state is to keep the amount of change in display state within a given range. This given range is set as appropriate, and is preferably set so that a user viewing displayed images can recognize the displayed images as the same image.

The G driver circuit 632 has the first mode and the second mode.

### <3-2-1. First Mode>

The G driver circuit 632 in the first mode outputs the G signals 632_G to pixels at a rate of higher than or equal to 30 times per second, preferably higher than or equal to 60 times per second and lower than 960 times per second.

The G driver circuit 632 in the first mode rewrites signals at a speed such that change in images which occurs each time signals are rewritten is not recognized by the user. As a result, a smooth moving image can be displayed.

### <3-2-2. Second Mode>

The G driver circuit 632 in the second mode outputs the G signals 632_G to pixels at a rate of higher than or equal to once per day and lower than 0.1 times per second, preferably higher than or equal to once per hour and lower than once per second.

In a period during which the G signal 632_G is not input, the pixel circuit 634 keeps holding the S signal 633_S and maintains the display state corresponding to the potential of the S signal 633_S.

In this manner, display without flicker due to rewriting of the display in the pixel can be performed in the second mode.

As a result, eye fatigue of a user of the display device can be reduced.

Power consumed by the G driver circuit 632 is reduced in a period during which the G driver circuit 632 does not operate.

Note that the pixel circuit that is driven by the G driver circuit 632 having the second mode is preferably configured to hold the S signal 633_S for a long period. For example, the off-state leakage current of the transistor 634t is preferably as low as possible.

Examples of a structure of the transistor 634t with low off-state leakage current are described in Embodiment 3 and Embodiment 4.

This embodiment can be combined with any of the other embodiments disclosed in this specification as appropriate.

### Embodiment 3

In this embodiment, a structural example of a display panel which can be used as a display unit in a display device of one embodiment of the present invention is described with reference to drawings.

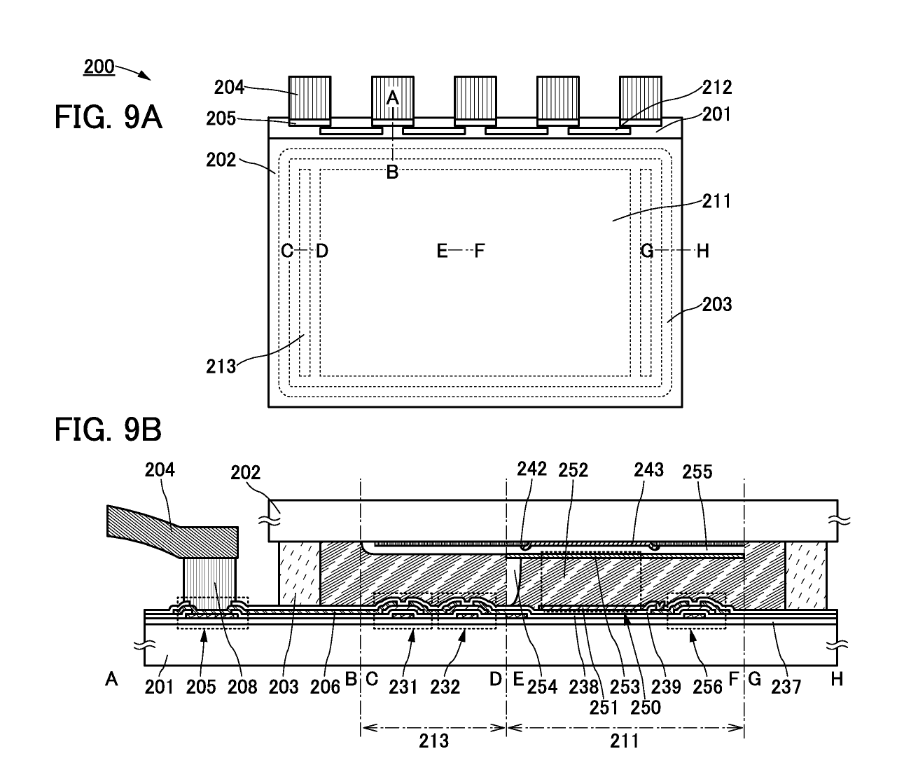

FIG. 9A is a schematic top view of a display panel 200 described as an example in this embodiment.

The display panel 200 includes a pixel portion 211 including a plurality of pixels and a gate driver circuit 213 in a sealed region surrounded by a first substrate 201, a second substrate 202, and a sealant 203. The display panel 200 also includes an external connection electrode 205 and an IC 212 functioning as a source driver circuit in a region outside the sealed region over the first substrate 201. Power and signals for driving the pixel portion 211, the gate driver circuit 213, the IC 212, and the like can be input through an FPC 204 electrically connected to the external connection electrode 205.

FIG. 9B is a schematic cross-sectional view of a region including the FPC 204 and the sealant 203 along the section line A-B, a region including and the gate driver circuit 213 along the section line C-D, a region including the pixel portion 211 along the section line E-F, and a region including the sealant 203 along the section line G-H in FIG. 9A.

The first substrate 201 and the second substrate 202 are bonded to each other with the sealant 203 in regions of the substrates which are close to the outer edges. In a region surrounded by the first substrate 201, the second substrate 202, and the sealant 203, at least the pixel portion 211 is provided.

In FIG. 9B, the gate driver circuit 213 includes a circuit in which n-channel transistors, transistors 231 and 232, are used in combination, as an example. Note that the gate driver circuit 213 is not limited to this structure and may include various CMOS circuits in which an n-channel transistor and a p-channel transistor are used in combination or a circuit in which p-channel transistors are used in combination. Although a driver-integrated structure in which the gate driver circuit 213 is formed over the first substrate 201 is described in this structural example, the gate driver circuit or the source driver circuit, or both may be formed over a substrate different from the first substrate 201. For example, a driver circuit IC may be mounted by a COG method, or a flexible substrate (FPC) mounted with a driver circuit IC by a COF method may be mounted. In this structural example, the IC 212 functioning as a source driver circuit is provided over the first substrate 201 by a COG method.

Note that there is no particular limitation on the structures of the transistors included in the pixel portion 211 and the gate driver circuit 213. For example, a forward staggered transistor or an inverted staggered transistor may be used. Further, a top-gate transistor or a bottom-gate transistor may be used. As a semiconductor material used for the transistors, for example, a semiconductor material such as silicon or germanium or an oxide semiconductor containing at least one of indium, gallium, and zinc may be used.

Further, there is no particular limitation on the crystallinity of a semiconductor used for the transistors, and an amorphous semiconductor or a semiconductor having crystallinity (a microcrystalline semiconductor, a polycrystalline semiconductor, a single crystal semiconductor, or a semiconductor partly including crystal regions) may be used. A semiconductor having crystallinity is preferably used, in which case deterioration of transistor characteristics can be reduced.

Typical examples of the oxide semiconductor containing at least one of indium, gallium, and zinc include an In—Ga—Zn-based metal oxide. An oxide semiconductor having a wider band gap and a lower carrier density than silicon is preferably used because off-state leakage current can be reduced. Details of preferred oxide semiconductors will be described below in another embodiment.

FIG. 9B shows a cross-sectional structure of one pixel as an example of the pixel portion 211. The pixel portion 211 includes a liquid crystal element 250 using a vertical alignment (VA) mode.

One pixel includes at least a switching transistor 256 and may also include a storage capacitor which is not shown. In addition, a first electrode 251 is provided over an insulating layer 239 to be electrically connected to a source electrode or a drain electrode of the transistor 256.

The liquid crystal element 250 provided for a pixel includes the first electrode 251 provided over the insulating layer 239, a second electrode 253 provided for the second substrate 202, and a liquid crystal 252 sandwiched between the first electrode 251 and the second electrode 253.

For the first electrode 251 and the second electrode 253, a light-transmitting conductive material is used. As the light-transmitting conductive material, a conductive oxide such as indium oxide, indium tin oxide, indium zinc oxide, zinc oxide, or zinc oxide to which gallium is added, or graphene can be used.

Further, a color filter 243 and a black matrix 242 are provided on the second substrate 202 in at least a region overlapping with the pixel portion 211.

The color filter 243 is provided in order to adjust the color of light transmitted through a pixel to increase the color purity. For example, in a full-color display panel using a white backlight, a plurality of pixels provided with color filters of different colors is used. In that case, the color filters may be those of three colors of R (red), G (green), and B (blue) or four colors (yellow (Y) in addition to these three colors). Further, a white (W) pixel may be added to R, G, and B pixels (and a Y pixel). That is, color filters of three colors (or four colors) may be used.

A black matrix 242 is provided between the adjacent color filters 243. The black matrix 242 blocks light emitted from an adjacent pixel, thereby preventing color mixture between the adjacent pixels. In one configuration, the black matrix 242 may be provided only between adjacent pixels of different emission colors and not between pixels of the same emission color. Here, the color filter 243 is provided so that its end portions overlap with the black matrix 242, whereby light leakage can be reduced. The black matrix 242 can be formed using a material that blocks light transmitted through the pixel, for example, a metal material or a resin material including a pigment. Note that it is preferable to provide the black matrix 242 also in a region overlapping with the gate driver circuit 213 or the like besides the pixel portion 211 as illustrated in FIG. 9B, in which case undesired leakage of guided light or the like can be prevented.

An overcoat 255 is provided so as to cover the color filter 243 and the black matrix 242. The overcoat 255 can suppress diffusion of impurities such as a pigment, which are included in the color filter 243 and the black matrix 242, into the liquid crystal 252. For the overcoat, a light-transmitting material is used, and an inorganic insulating material or an organic insulating material can be used.

Note that the second electrode 253 is provided on the overcoat 255.

In addition, a spacer 254 is provided in a region where the overcoat 255 overlaps with the black matrix 242. The spacer 254 is preferably formed using a resin material because it can be formed thick. For example, the spacer 254 can be formed using a positive or negative photosensitive resin. When a light-blocking material is used for the spacer 254, the spacer 254 blocks light emitted from an adjacent pixel, thereby preventing color mixture between the adjacent pixels. Although the spacer 254 is provided on the second substrate 202 side in this structural example, the spacer 254 may be provided on the first substrate 201 side. Further, a structure may be employed in which spherical silicon oxide particles are used as the spacer 254 and the particles are scattered in a region where the liquid crystal 252 is provided.

An image can be displayed in the following way: an electric field is generated in the vertical direction with respect to an electrode surface by application of voltage between the first electrode 251 and the second electrode 253, alignment of the liquid crystal 252 is controlled by the electric field, and polarization of light from a backlight provided outside the display panel is controlled in each pixel.

An alignment film that controls alignment of the liquid crystal 252 may be provided on a surface in contact with the liquid crystal 252. A light-transmitting material is used for the alignment film.

In this structural example, a color filter is provided in a region overlapping with the liquid crystal element 250; thus, a full-color image with high color purity can be displayed. With the use of a plurality of light-emitting diodes (LEDs) which emit light of different colors as a backlight, a time-division display method (a field-sequential driving method) can be employed. In the case of employing a time-division display method, the aperture ratio of each pixel or the number of pixels per unit area can be increased because neither color filters nor subpixels from which light of red (R), green (G), or blue (B), for example, is obtained are needed.

As the liquid crystal 252, a thermotropic liquid crystal, a low-molecular liquid crystal, a polymer liquid crystal, a ferroelectric liquid crystal, an anti-ferroelectric liquid crystal, or the like can be used. Moreover, a liquid crystal exhibiting a blue phase is preferably used because an alignment film is not needed and a wide viewing angle is obtained in that case. It is also possible to use a polymer-stabilized liquid crystal material which is obtained by adding a monomer and a polymerization initiator to the above liquid crystal and, after injection or dropping and sealing of the liquid crystal, polymerizing the monomer.

Although the liquid crystal element 250 using a VA mode is described in this structural example, the structure of the liquid crystal element is not limited to this example, and the liquid crystal element 250 using a different mode can be used. For example, an in-plane-switching (IPS) mode, a twisted nematic (TN) mode, a fringe field switching (FFS) mode, an axially symmetric aligned micro-cell (ASM) mode, an optically compensated birefringence (OCB) mode, a ferroelectric liquid crystal (FLC) mode, an anti-ferroelectric liquid crystal (AFLC) mode, or the like can be used.

The first substrate 201 is provided with an insulating layer 237 in contact with an upper surface of the first substrate 201, an insulating layer 238 functioning as a gate insulating layer of transistors, and the insulating layer 239 covering the transistors.

The insulating layer 237 is provided in order to prevent diffusion of impurities included in the first substrate 201. The insulating layers 238 and 239, which are in contact with semiconductor layers of the transistors, are preferably formed using a material which prevents diffusion of impurities that promote degradation of the transistors. For these insulating layers, for example, an oxide, a nitride, or an oxynitride of a semiconductor such as silicon or a metal such as aluminum can be used. Alternatively, a stack of such inorganic insulating materials or a stack of such an inorganic insulating material and an organic insulating material may be used. Note that the insulating layers 237 and 239 are not necessarily provided when not needed.

An insulating layer functioning as a planarization layer which covers steps due to the transistors, a wiring, or the like provided therebelow may be provided between the insulating layer 239 and the first electrode 251. For such an insulating layer, it is preferable to use a resin material such as polyimide or acrylic. An inorganic insulating material may be used as long as high planarity can be obtained.

With the structure shown in FIG. 9B, the number of photomasks needed for forming a transistor and the first electrode 251 of the liquid crystal element 250 over the first substrate 201 can be reduced. Specifically, five photomasks are needed; one is used in a step of processing a gate electrode, one is used in a step of processing a semiconductor layer, one is used in a step of processing a source electrode and a drain electrode, one is used in a step of forming an opening in the insulating layer 239, and one is used in a step of processing the first electrode 251.

A wiring 206 over the first substrate 201 is provided so as to extend to the outside of the region sealed with the sealant 203 and is electrically connected to the gate driver circuit 213. Part of an end portion of the wiring 206 forms part of the external connection electrode 205. In this structural example, the external connection electrode 205 is formed by a stack of a conductive film used for the source electrode and the drain electrode of the transistor and a conductive film used for the gate electrode of the transistor. The external connection electrode 205 is preferably formed by a stack of a plurality of conductive films as described above because mechanical strength against a pressure bonding step performed on the FPC 204 or the like can be increased.

Although not shown, a wiring and an external connection electrode which electrically connect the IC 212 and the pixel portion 211 may have structures similar to those of the wiring 206 and the external connection electrode 205.

A connection layer 208 is provided in contact with the external connection electrode 205. The FPC 204 is electrically connected to the external connection electrode 205 through the connection layer 208. For the connection layer 208, a known anisotropic conductive film, a known anisotropic conductive paste, or the like can be used.

The end portions of the wiring 206 and the external connection electrode 205 are preferably covered with an insulating layer so that surfaces thereof are not exposed, in which case oxidation of the surfaces and defects such as an unintended short circuit can be suppressed.

This embodiment can be combined with any of the other embodiments disclosed in this specification as appropriate.

### Embodiment 4

An example of a semiconductor which is preferably used for the region where a channel is formed in the transistor which is shown as an example in the above embodiment is described below.

An oxide semiconductor has a wide energy gap of 3.0 eV or more. A transistor including an oxide semiconductor film obtained by processing of the oxide semiconductor in an appropriate condition and a sufficient reduction in carrier density of the oxide semiconductor can have much lower leakage current between a source and a drain in an off state (off-state current) than a conventional transistor including silicon.

In the case where an oxide semiconductor film is used for a transistor, the thickness of the oxide semiconductor film is preferably greater than or equal to 2 nm and less than or equal to 40 nm.

An applicable oxide semiconductor preferably contains at least indium (In) or zinc (Zn). In particular, In and Zn are preferably contained. In addition, as a stabilizer for reducing variation in electrical characteristics of a transistor using the oxide semiconductor, one or more elements selected from gallium (Ga), tin (Sn), hafnium (HO, zirconium (Zr), titanium (Ti), scandium (Sc), yttrium (Y), and a lanthanoid (such as cerium (Ce), neodymium (Nd), or gadolinium (Gd)) is preferably contained.

As the oxide semiconductor, for example, any of the following can be used: indium oxide, tin oxide, zinc oxide, an In—Zn-based oxide, a Sn—Zn-based oxide, an Al—Zn-based oxide, a Zn—Mg-based oxide, a Sn—Mg-based oxide, an In—Mg-based oxide, an In—Ga-based oxide, an In—Ga—Zn-based oxide (also referred to as IGZO), an In—Al—Zn-based oxide, an In—Sn—Zn-based oxide, a Sn—Ga—Zn-based oxide, an Al—Ga—Zn-based oxide, a Sn—Al—Zn-based oxide, an In—Hf—Zn-based oxide, an In—Zr—Zn-based oxide, an In—Ti—Zn-based oxide, an In—Sc—Zn-based oxide, an In—Y—Zn-based oxide, an In—La—Zn-based oxide, an In—Ce—Zn-based oxide, an In—Pr—Zn-based oxide, an In—Nd—Zn-based oxide, an In—Sm—Zn-based oxide, an In—Eu—Zn-based oxide, an In—Gd—Zn-based oxide, an In—Tb—Zn-based oxide, an In—Dy—Zn-based oxide, an In—Ho—Zn-based oxide, an In—Er—Zn-based oxide, an In—Tm—Zn-based oxide, an In—Yb—Zn-based oxide, an In—Lu—Zn-based oxide, an In—Sn—Ga—Zn-based oxide, an In—Hf—Ga—Zn-based oxide, an In—Al—Ga—Zn-based oxide, an In—Sn—Al—Zn-based oxide, an In—Sn—Hf—Zn-based oxide, or an In—Hf—Al—Zn-based oxide.

Here, an “In—Ga—Zn-based oxide” means an oxide containing In, Ga, and Zn as its main components and there is no particular limitation on the ratio of In, Ga, and Zn. Further, the In—Ga—Zn-based oxide may contain a metal element other than In, Ga, and Zn.

Alternatively, a material represented by InMO₃(ZnO)ₘ (m>0 is satisfied, and m is not an integer) may be used as the oxide semiconductor. Note that M represents one or more metal elements selected from Ga, Fe, Mn, and Co, or the above-described element as a stabilizer. Alternatively, as the oxide semiconductor, a material represented by In₂SnO₅(ZnO)ₙ (n>0 is satisfied, and n is an integer) may be used.

For example, an In—Ga—Zn-based oxide with an atomic ratio of In:Ga:Zn=1:1:1, In:Ga:Zn=3:1:2, or In:Ga:Zn=2:1:3, or an oxide with an atomic ratio close to the above atomic ratios can be used.

When the oxide semiconductor film contains a large amount of hydrogen, the hydrogen and an oxide semiconductor are bonded to each other, so that part of the hydrogen serves as a donor and causes generation of an electron which is a carrier. As a result, the threshold voltage of the transistor shifts in the negative direction. Therefore, it is preferable that, after formation of the oxide semiconductor film, dehydration treatment (dehydrogenation treatment) be performed to remove hydrogen or moisture from the oxide semiconductor film so that the oxide semiconductor film is highly purified to contain impurities as little as possible.

Note that oxygen in the oxide semiconductor film is also reduced by the dehydration treatment (dehydrogenation treatment) in some cases. Accordingly, it is preferable that oxygen be added to the oxide semiconductor film to fill oxygen vacancies increased by the dehydration treatment (dehydrogenation treatment). In this specification and the like, supplying oxygen to an oxide semiconductor film may be expressed as oxygen adding treatment, and treatment for making the oxygen content of an oxide semiconductor film be in excess of that in the stoichiometric composition may be expressed as treatment for making an oxygen-excess state.

In this manner, hydrogen or moisture is removed from the oxide semiconductor film by the dehydration treatment (dehydrogenation treatment) and oxygen vacancies therein are filled by the oxygen adding treatment, whereby the oxide semiconductor film can be turned into an i-type (intrinsic) oxide semiconductor film or a substantially i-type (intrinsic) oxide semiconductor film which is extremely close to an i-type oxide semiconductor film. Note that “substantially intrinsic” means that the oxide semiconductor film contains extremely few (close to zero) carriers derived from a donor and has a carrier density of lower than or equal to 1×10¹⁷/cm³, lower than or equal to 1×10¹⁶/cm³, lower than or equal to 1×10¹⁵/cm³, lower than or equal to 1×10¹⁴/cm³, or lower than or equal to 1×10¹³/cm³.

Thus, the transistor including an i-type or substantially i-type oxide semiconductor film can have extremely favorable off-state current characteristics. For example, the drain current at the time when the transistor including an oxide semiconductor film is in an off-state can be less than or equal to 1×10⁻¹⁸ A, preferably less than or equal to 1×10⁻²¹ A, further preferably less than or equal to 1×10⁻²⁴ A at room temperature (about 25° C.); or less than or equal to 1×10⁻¹⁵ A, preferably less than or equal to 1×10⁻¹⁸ A, further preferably less than or equal to 1×10⁻²¹ A at 85° C. An off state of a transistor refers to a state where gate voltage is sufficiently lower than the threshold voltage in an n-channel transistor. Specifically, the transistor is in an off state when the gate voltage is lower than the threshold voltage by 1V or more, 2V or more, or 3V or more.

A structure of an oxide semiconductor film is described below.

In this specification, a term “parallel” indicates that the angle formed between two straight lines is greater than or equal to −10° and less than or equal to 10°, and accordingly also includes the case where the angle is greater than or equal to −5° and less than or equal to 5°. In addition, a term “perpendicular” indicates that the angle formed between two straight lines is greater than or equal to 80° and less than or equal to 100°, and accordingly includes the case where the angle is greater than or equal to 85° and less than or equal to 95°.

In this specification, trigonal and rhombohedral crystal systems are included in a hexagonal crystal system.

An oxide semiconductor film is classified roughly into a single-crystal oxide semiconductor film and a non-single-crystal oxide semiconductor film. The non-single-crystal oxide semiconductor film includes any of a c-axis aligned crystalline oxide semiconductor (CAAC-OS) film, a polycrystalline oxide semiconductor film, a microcrystalline oxide semiconductor film, an amorphous oxide semiconductor film, and the like.

First, a CAAC-OS film is described.

The CAAC-OS film is one of oxide semiconductor films having a plurality of c-axis aligned crystal parts.

In a transmission electron microscope (TEM) image of the CAAC-OS film, a boundary between crystal parts, that is, a grain boundary is not clearly observed. Thus, in the CAAC-OS film, a reduction in electron mobility due to the grain boundary is less likely to occur.

According to the TEM image of the CAAC-OS film observed in a direction substantially parallel to a sample surface (cross-sectional TEM image), metal atoms are arranged in a layered manner in the crystal parts. Each metal atom layer has a morphology reflected by a surface over which the CAAC-OS film is formed (hereinafter, a surface over which the CAAC-OS film is formed is referred to as a formation surface) or a top surface of the CAAC-OS film, and is arranged in parallel to the formation surface or the top surface of the CAAC-OS film.

On the other hand, according to the TEM image of the CAAC-OS film observed in a direction substantially perpendicular to the sample surface (plan TEM image), metal atoms are arranged in a triangular or hexagonal configuration in the crystal parts. However, there is no regularity of arrangement of metal atoms between different crystal parts.

From the results of the cross-sectional TEM image and the plan TEM image, alignment is found in the crystal parts in the CAAC-OS film.

Most of the crystal parts included in the CAAC-OS film each fit inside a cube whose one side is less than 100 nm. Thus, there is a case where a crystal part included in the CAAC-OS film fits inside a cube whose one side is less than 10 nm, less than 5 nm, or less than 3 nm. Note that when a plurality of crystal parts included in the CAAC-OS film are connected to each other, one large crystal region is formed in some cases. For example, a crystal region with an area of 2500 nm² or more, 5 μm² or more, or 1000 μm² or more is observed in some cases in the plan TEM image.

A CAAC-OS film is subjected to structural analysis with an X-ray diffraction (XRD) apparatus. For example, when the CAAC-OS film including an InGaZnO₄ crystal is analyzed by an out-of-plane method, a peak appears frequently when the diffraction angle (2θ) is around 31°. This peak is derived from the (009) plane of the InGaZnO₄ crystal, which indicates that crystals in the CAAC-OS film have c-axis alignment, and that the c-axes are aligned in a direction substantially perpendicular to the formation surface or the top surface of the CAAC-OS film.

On the other hand, when the CAAC-OS film is analyzed by an in-plane method in which an X-ray enters a sample in a direction substantially perpendicular to the c-axis, a peak appears frequently when 2θ is around 56°. This peak is derived from the (110) plane of the InGaZnO₄ crystal. Here, analysis (φ scan) is performed under conditions where the sample is rotated around a normal vector of a sample surface as an axis (φ axis) with 2θ fixed at around 56°. In the case where the sample is a single-crystal oxide semiconductor film of InGaZnO₄, six peaks appear. The six peaks are derived from crystal planes equivalent to the (110) plane. On the other hand, in the case of a CAAC-OS film, a peak is not clearly observed even when φ scan is performed with 2θ fixed at around 56°.

According to the above results, in the CAAC-OS film having c-axis alignment, while the directions of a-axes and b-axes are different between crystal parts, the c-axes are aligned in a direction parallel to a normal vector of a formation surface or a normal vector of a top surface. Thus, each metal atom layer arranged in a layered manner observed in the cross-sectional TEM image corresponds to a plane parallel to the a-b plane of the crystal.

Note that the crystal part is formed concurrently with deposition of the CAAC-OS film or is formed through crystallization treatment such as heat treatment. As described above, the c-axis of the crystal is aligned with a direction parallel to a normal vector of a formation surface or a normal vector of a top surface. Thus, for example, in the case where a shape of the CAAC-OS film is changed by etching or the like, the c-axis might not be necessarily parallel to a normal vector of a formation surface or a normal vector of a top surface of the CAAC-OS film.

Further, distribution of c-axis aligned crystal parts in the CAAC-OS film is not necessarily uniform. For example, in the case where crystal growth leading to the crystal parts of the CAAC-OS film occurs from the vicinity of the top surface of the film, the proportion of the c-axis aligned crystal parts in the vicinity of the top surface is higher than that in the vicinity of the formation surface in some cases. Further, when an impurity is added to the CAAC-OS film, a region to which the impurity is added is altered, and the proportion of the c-axis aligned crystal parts in the CAAC-OS film varies depending on regions, in some cases.

Note that when the CAAC-OS film with an InGaZnO₄ crystal is analyzed by an out-of-plane method, a peak of 2θ may also be observed at around 36°, in addition to the peak of 2θ at around 31°. The peak of 2θ at around 36° indicates that a crystal having no c-axis alignment is included in part of the CAAC-OS film. It is preferable that in the CAAC-OS film, a peak of 2θ appear at around 31° and a peak of 2θ do not appear at around 36°.

The CAAC-OS film is an oxide semiconductor film having low impurity concentration. The impurity is an element other than the main components of the oxide semiconductor film, such as hydrogen, carbon, silicon, or a transition metal element. In particular, an element (e.g., silicon) that has higher bonding strength to oxygen than a metal element included in the oxide semiconductor film disturbs the atomic arrangement of the oxide semiconductor film by depriving the oxide semiconductor film of oxygen and causes a decrease in crystallinity. Further, a heavy metal such as iron or nickel, argon, carbon dioxide, or the like has a large atomic radius (or molecular radius), and thus disturbs the atomic arrangement of the oxide semiconductor film and causes a decrease in crystallinity when it is contained in the oxide semiconductor film. Note that the impurity contained in the oxide semiconductor film might serve as a carrier trap or a carrier generation source.

The CAAC-OS film is an oxide semiconductor film having a low density of defect states. In some cases, oxygen vacancies in the oxide semiconductor film serve as carrier traps or serve as carrier generation sources when hydrogen is captured therein.

The state in which impurity concentration is low and density of defect states is low (the number of oxygen vacancies is small) is referred to as a “highly purified intrinsic” or “substantially highly purified intrinsic” state. A highly purified intrinsic or substantially highly purified intrinsic oxide semiconductor film has few carrier generation sources, and thus can have a low carrier density. Thus, a transistor including the oxide semiconductor film rarely has negative threshold voltage (is rarely normally on). The highly purified intrinsic or substantially highly purified intrinsic oxide semiconductor film has few carrier traps. Accordingly, the transistor including the oxide semiconductor film has little variation in electrical characteristics and has high reliability. Note that charge trapped by the carrier traps in the oxide semiconductor film takes a long time to be released and might behave like fixed charge. Thus, a transistor including the oxide semiconductor film having high impurity concentration and a high density of defect states has unstable electrical characteristics in some cases.

In a transistor including the CAAC-OS film, change in the electrical characteristics of the transistor due to irradiation with visible light or ultraviolet light is small.

For example, a CAAC-OS film can be deposited by a sputtering method using a polycrystalline oxide semiconductor sputtering target. When ions collide with the sputtering target, a crystal region included in the sputtering target may be separated from the target along an a-b plane; in other words, a sputtered particle having a plane parallel to an a-b plane (flat-plate-like sputtered particle or pellet-like sputtered particle) may flake off from the sputtering target. In that case, the flat-plate-like sputtered particle or the pellet-like sputtered particle reaches a surface where the CAAC-OS film is to be deposited while maintaining its crystal state, whereby the CAAC-OS film can be deposited.

The flat-plate-like sputtered particle has, for example, an equivalent circle diameter of a plane parallel to the a-b plane of greater than or equal to 3 nm and less than or equal to 10 nm, and a thickness (length in the direction perpendicular to the a-b plane) of greater than or equal to 0.7 nm and less than 1 nm. Note that in the flat-plate-like sputtered particle, the plane parallel to the a-b plane may be a regular triangle or a regular hexagon. Here, the term “equivalent circle diameter of a plane” refers to the diameter of a perfect circle having the same area as the plane.

For the deposition of the CAAC-OS film, the following conditions are preferably used.

When the substrate temperature during the deposition is increased, migration of the flat-plate-like sputtered particles which have reached the substrate occurs, so that a flat plane of each sputtered particle is attached to the substrate. At this time, the sputtered particles are positively charged, thereby being attached to the substrate while repelling each other; thus, the sputtered particles are not stacked unevenly, so that a CAAC-OS film with a uniform thickness can be deposited. Specifically, the substrate temperature during the deposition is preferably higher than or equal to 100° C. and lower than or equal to 740° C., more preferably higher than or equal to 200° C. and lower than or equal to 500° C.

By reducing the amount of impurities entering the CAAC-OS film during the deposition, the crystal state can be prevented from being broken by the impurities. For example, the concentration of impurities (e.g., hydrogen, water, carbon dioxide, or nitrogen) which exist in a deposition chamber may be reduced. Furthermore, the concentration of impurities in a deposition gas may be reduced. Specifically, a deposition gas whose dew point is −80° C. or lower, preferably −100° C. or lower is used.

Furthermore, it is preferable that the proportion of oxygen in the deposition gas be increased and the power be optimized in order to reduce plasma damage at the deposition. The proportion of oxygen in the deposition gas is higher than or equal to 30 vol %, preferably 100 vol %.

After the CAAC-OS film is deposited, heat treatment may be performed. The temperature of the heat treatment is higher than or equal to 100° C. and lower than or equal to 740° C., preferably higher than or equal to 200° C. and lower than or equal to 500° C. The heat treatment time is longer than or equal to 1 minute and shorter than or equal to 24 hours, preferably longer than or equal to 6 minutes and shorter than or equal to 4 hours. The heat treatment may be performed in an inert atmosphere or an oxidation atmosphere. It is preferable to perform heat treatment in an inert atmosphere and then perform heat treatment in an oxidation atmosphere. The heat treatment in an inert atmosphere can reduce the concentration of impurities in the CAAC-OS film in a short time. At the same time, the heat treatment in an inert atmosphere may generate oxygen vacancies in the CAAC-OS film. In such a case, the heat treatment in an oxidation atmosphere can reduce the oxygen vacancies. The heat treatment can further increase the crystallinity of the CAAC-OS film. Note that the heat treatment may be performed under a reduced pressure, such as 1000 Pa or lower, 100 Pa or lower, 10 Pa or lower, or 1 Pa or lower. The heat treatment under the reduced pressure can reduce the concentration of impurities in the CAAC-OS film in a shorter time.

As an example of the sputtering target, an In—Ga—Zn—O compound target is described below.

The In—Ga—Zn—O compound target, which is polycrystalline, is made by mixing InO_{X} powder, GaO_{Y} powder, and ZnO_{Z} powder in a predetermined molar ratio, applying pressure, and performing heat treatment at a temperature higher than or equal to 1000° C. and lower than or equal to 1500° C. Note that X, Y, and Z are each a given positive number. Here, the predetermined molar ratio of InOₓ powder to GaO_{y} powder and ZnO_{z} powder is, for example, 1:1:1, 1:1:2, 1:3:2, 2:1:3, 2:2:1, 3:1:1, 3:1:2, 3:1:4, 4:2:3, 8:4:3, or a ratio close to these ratios. The kinds of powder and the molar ratio for mixing powder may be determined as appropriate depending on the desired sputtering target.

Alternatively, the CAAC-OS film may be formed by the following method.

First, a first oxide semiconductor film is formed to a thickness of greater than or equal to 1 nm and less than 10 nm. The first oxide semiconductor film is formed by a sputtering method. Specifically, the substrate temperature is set to higher than or equal to 100° C. and lower than or equal to 500° C., preferably higher than or equal to 150° C. and lower than or equal to 450° C., and the proportion of oxygen in a deposition gas is set to higher than or equal to 30 vol %, preferably 100 vol %.

Next, heat treatment is performed so that the first oxide semiconductor film becomes a first CAAC-OS film with high crystallinity. The temperature of the heat treatment is higher than or equal to 350° C. and lower than or equal to 740° C., preferably higher than or equal to 450° C. and lower than or equal to 650° C. The heat treatment time is longer than or equal to 1 minute and shorter than or equal to 24 hours, preferably longer than or equal to 6 minutes and shorter than or equal to 4 hours. The heat treatment may be performed in an inert atmosphere or an oxidation atmosphere. It is preferable to perform heat treatment in an inert atmosphere and then perform heat treatment in an oxidation atmosphere. The heat treatment in an inert atmosphere can reduce the concentration of impurities in the first oxide semiconductor film in a short time. At the same time, the heat treatment in an inert atmosphere may generate oxygen vacancies in the first oxide semiconductor film. In such a case, the heat treatment in an oxidation atmosphere can reduce the oxygen vacancies. Note that the heat treatment may be performed under a reduced pressure, such as 1000 Pa or lower, 100 Pa or lower, 10 Pa or lower, or 1 Pa or lower. The heat treatment under the reduced pressure can reduce the concentration of impurities in the first oxide semiconductor film in a shorter time.

The first oxide semiconductor film with a thickness of greater than or equal to 1 nm and less than 10 nm can be easily crystallized by heat treatment as compared to the case where the first oxide semiconductor film has a thickness of greater than or equal to 10 nm.

Next, a second oxide semiconductor film having the same composition as the first oxide semiconductor film is formed to a thickness of greater than or equal to 10 nm and less than or equal to 50 nm. The second oxide semiconductor film is formed by a sputtering method. Specifically, the substrate temperature is set to higher than or equal to 100° C. and lower than or equal to 500° C., preferably higher than or equal to 150° C. and lower than or equal to 450° C., and the proportion of oxygen in a deposition gas is set to higher than or equal to 30 vol %, preferably 100 vol %.

Next, heat treatment is performed so that solid phase growth of the second oxide semiconductor film from the first CAAC-OS film occurs, whereby the second oxide semiconductor film is turned into a second CAAC-OS film having high crystallinity. The temperature of the heat treatment is higher than or equal to 350° C. and lower than or equal to 740° C., preferably higher than or equal to 450° C. and lower than or equal to 650° C. The heat treatment time is longer than or equal to 1 minute and shorter than or equal to 24 hours, preferably longer than or equal to 6 minutes and shorter than or equal to 4 hours. The heat treatment may be performed in an inert atmosphere or an oxidation atmosphere. It is preferable to perform heat treatment in an inert atmosphere and then perform heat treatment in an oxidation atmosphere. The heat treatment in an inert atmosphere can reduce the concentration of impurities in the second oxide semiconductor film in a short time. At the same time, the heat treatment in an inert atmosphere may generate oxygen vacancies in the second oxide semiconductor film. In such a case, the heat treatment in an oxidation atmosphere can reduce the oxygen vacancies. Note that the heat treatment may be performed under a reduced pressure, such as 1000 Pa or lower, 100 Pa or lower, 10 Pa or lower, or 1 Pa or lower. The heat treatment under the reduced pressure can reduce the concentration of impurities in the second oxide semiconductor film in a shorter time.

In the above-described manner, a CAAC-OS film having a total thickness of 10 nm or more can be formed.

Further, the oxide semiconductor film may have a structure in which a plurality of oxide semiconductor films is stacked.

For example, a structure may be employed in which, between an oxide semiconductor film (referred to as a first layer for convenience) and a gate insulating film, a second layer which is formed using the constituent element of the first layer and whose electron affinity is lower than that of the first layer by 0.2 eV or more is provided. In this case, when an electric field is applied from a gate electrode, a channel is formed in the first layer, and a channel is not formed in the second layer. The constituent element of the first layer is the same as the constituent element of the second layer, and thus interface scattering hardly occurs at the interface between the first layer and the second layer. Accordingly, when the second layer is provided between the first layer and the gate insulating film, the field-effect mobility of the transistor can be increased.

Further, in the case where a silicon oxide film, a silicon oxynitride film, a silicon nitride oxide film, or a silicon nitride film is used as the gate insulating film, silicon contained in the gate insulating film enters the oxide semiconductor film in some cases. When the oxide semiconductor film contains silicon, reductions in crystallinity and carrier mobility of the oxide semiconductor film occur, for example. Thus, it is preferable to provide the second layer between the first layer and the gate insulating film in order to reduce the concentration of silicon in the first layer where a channel is formed. For the same reason, it is preferable to provide a third layer which is formed using the constituent element of the first layer and whose electron affinity is lower than that of the first layer by 0.2 eV or more so that the first layer is interposed between the second layer and the third layer.

Such a structure makes it possible to reduce and further prevent diffusion of impurities such as silicon to a region where a channel is formed, so that a highly reliable transistor can be obtained.

Note that in order to make the oxide semiconductor film a CAAC-OS film, the concentration of silicon contained in the oxide semiconductor film is set to lower than or equal to 2.5×10²¹/cm³, preferably lower than 1.4×10²¹/cm³, more preferably lower than 4×10¹⁹/cm³, still more preferably lower than 2.0×10¹⁸/cm³. This is because the field-effect mobility of the transistor may be reduced when the concentration of silicon contained in the oxide semiconductor film is higher than or equal to 1.4×10²¹/cm³, and the oxide semiconductor film may be made amorphous at the interface between the oxide semiconductor film and a film in contact with the oxide semiconductor film when the concentration of silicon contained in the oxide semiconductor film is higher than or equal to 4.0×10¹⁹/cm³. Further, when the concentration of silicon contained in the oxide semiconductor film is lower than 2.0×10¹⁸/cm³, further improvement in reliability of the transistor and a reduction in density of states (DOS) in the oxide semiconductor film can be expected. Note that the concentration of silicon in the oxide semiconductor film can be measured by secondary ion mass spectroscopy (SIMS).

Next, a microcrystalline oxide semiconductor film is described.

In a TEM image of the microcrystalline oxide semiconductor film, crystal parts cannot be found clearly in some cases. In most cases, the size of a crystal part in the microcrystalline oxide semiconductor film is greater than or equal to 1 nm and less than or equal to 100 nm, or greater than or equal to 1 nm and less than or equal to 10 nm. A microcrystal with a size greater than or equal to 1 nm and less than or equal to 10 nm, or a size greater than or equal to 1 nm and less than or equal to 3 nm is specifically referred to as nanocrystal (nc). An oxide semiconductor film including nanocrystal is referred to as an nc-OS (nanocrystalline oxide semiconductor) film. In a TEM image of the nc-OS film, a crystal grain cannot be found clearly in some cases.

In the nc-OS film, a microscopic region (e.g., a region with a size greater than or equal to 1 nm and less than or equal to 10 nm, in particular, a region with a size greater than or equal to 1 nm and less than or equal to 3 nm) has a periodic atomic order. Further, there is no regularity of crystal orientation between different crystal parts in the nc-OS film; thus, the orientation of the whole film is not observed. Accordingly, in some cases, the nc-OS film cannot be distinguished from an amorphous oxide semiconductor film depending on an analysis method. For example, when the nc-OS film is subjected to structural analysis by an out-of-plane method with an XRD apparatus using an X-ray having a diameter larger than that of a crystal part, a peak which shows a crystal plane does not appear. Further, a halo pattern is shown in a selected-area electron diffraction pattern of the nc-OS film obtained by using an electron beam having a probe diameter larger than the diameter of a crystal part (e.g., larger than or equal to 50 nm). Meanwhile, spots are shown in a nanobeam electron diffraction pattern of the nc-OS film obtained by using an electron beam having a probe diameter close to or smaller than the diameter of a crystal part (e.g., larger than or equal to 1 nm and smaller than or equal to 30 nm). Further, in a nanobeam electron diffraction pattern of the nc-OS film, regions with high luminance in a circular (ring) pattern are shown in some cases. Also in a nanobeam electron diffraction pattern of the nc-OS film, a plurality of spots are shown in a ring-like region in some cases.

Since the nc-OS film is an oxide semiconductor film having more regularity than the amorphous oxide semiconductor film, the nc-OS film has a lower density of defect states than the amorphous oxide semiconductor film. However, there is no regularity of crystal orientation between different crystal parts in the nc-OS film; hence, the nc-OS film has a higher density of defect states than the CAAC-OS film.

Note that an oxide semiconductor film may be a stacked film including two or more films of an amorphous oxide semiconductor film, a microcrystalline oxide semiconductor film, and a CAAC-OS film, for example.

This embodiment can be combined with any of the other embodiments disclosed in this specification as appropriate.

### Embodiment 5

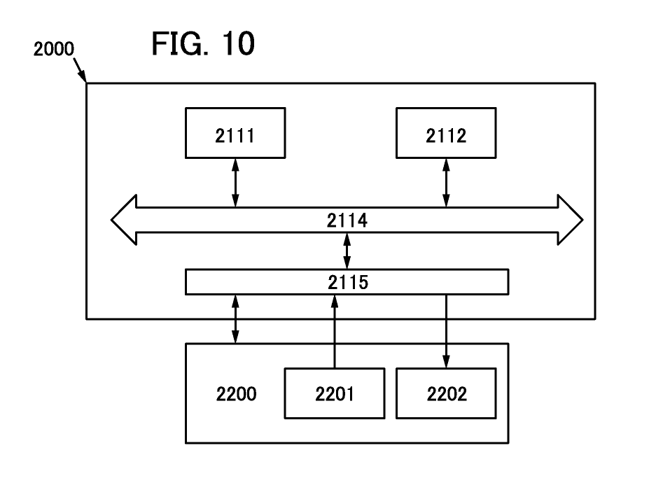

In this embodiment, a structure of hardware for executing a program of one embodiment of the present invention will be described with reference to FIG. 10.

A program described as an example in this embodiment is a program for driving a display device including a display unit, a detection unit, and a control unit. The program includes the steps of making the detection unit detect a condition of a user's eye to obtain detected information and transmit the detected information to the control unit; and making the control unit extract fatigue information on the user from the detected information and drive the display unit such that a luminance of light with a wavelength shorter than or equal to a predetermined wavelength among light emitted from the display unit is changed on the basis of the fatigue information. An arithmetic device executes the program.

In this program, the luminance of short-wavelength light is lowered in accordance with the user's fatigue condition detected by the condition of the user's eye. The program makes it possible to reduce the user's eye fatigue and damage to the retina and prevent harm to the user's health.

FIG. 10 is a block diagram illustrating an example of a structure of an arithmetic device 2000 which executes a program of one embodiment of the present invention.

The arithmetic device 2000 includes a central processor 2111, a memory device 2112, and a transmission path 2114. The transmission path 2114 connects the central processor 2111, the memory device 2112, and an input/output interface 2115 to each other and transmits information.

An input/output device 2200 is connected to the transmission path 2114 via the input/output interface 2115. The input/output device 2200 is a device for inputting information to the arithmetic device 2000 from the outside or outputting information to the outside from the arithmetic device 2000.

As examples of the input/output device 2200, a communication device, a network connection device, and a writable external memory device such as a hard disk or a removable memory can be given.

As examples of an input device 2201, a human interface device such as a keyboard, a pointing device (e.g., a mouse), or a touch panel, a camera such as a digital camera or a digital video camera, a scanner, and a read-only external memory device such as a CD-ROM or a DVD-ROM can be given.

As examples of an output device 2202, a display panel, a speaker, a printer, and the like can be given.

The program of one embodiment of the present invention can be distributed via read-only storage media into which the program has been written or via a network by download.

The central processor 2111 of the arithmetic device 2000 reads the program of one embodiment of the present invention into the memory device 2112 from the external memory device in the input/output device 2200. Then, the central processor 2111 executes arithmetic processing in accordance with the procedure of the above program.

The arithmetic device 2000 outputs the result of executing the program to the output device 2202 via the input/output interface 2115.

Note that this embodiment can be combined with any of the other embodiments in this specification as appropriate.

### Embodiment 6

In this embodiment, examples of electronic devices each including a display device of one embodiment of the present invention will be described with reference to drawings.

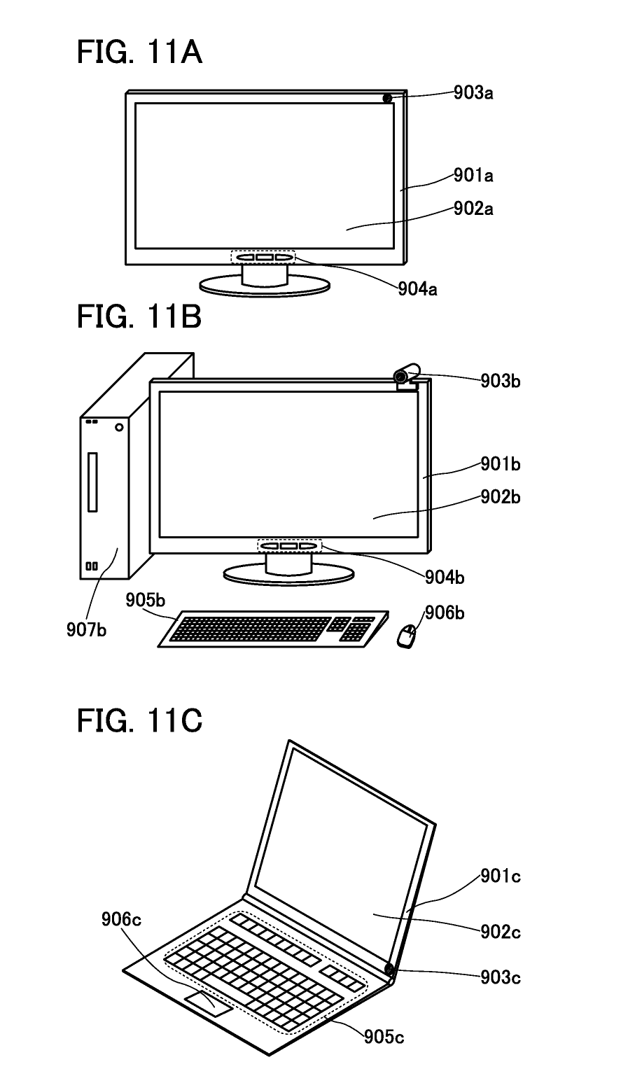

Examples of such an electronic device for which a display device according to one embodiment of the present invention is used include the following: television sets (also called TV or television receivers); monitors for computers or the like; cameras such as digital cameras or digital video cameras; digital photo frames; mobile phones (also called cellular phones or portable telephones); portable game machines; portable information terminals; audio playback devices; and large game machines such as pachinko machines. FIGS. 11A to 11C illustrate specific examples of these electronic devices.

An electronic device illustrated in FIG. 11A is an example of a monitor.

The electronic device in FIG. 11A includes a housing 901a, a display portion 902a, a camera 903a, and an input unit 904a.

The display portion 902a is incorporated in the housing 901a. The display portion 902a can display images. The housing 901a is supported by a stand provided below.

The camera 903a as a detection unit is incorporated in the housing 901a. An image of a user's eyeball and the like can be taken by the camera 903a.

The input unit 904a is incorporated in the housing 901a. With the input unit 904a, the user can input a variety of setting information.

Further, a control unit is provided inside the housing 901a.

In the electronic device in FIG. 11A, detected information is obtained with the camera 903a, and the luminance of light emitted from the display portion 902a as a display unit can be controlled by the control unit inside the housing 901a. This structure makes it possible to reduce the user's eye fatigue and damage to the retina and prevent harm to the user's health.

An electronic device illustrated in FIG. 11B is an example of a personal computer.

The electronic device in FIG. 11B includes a housing 901b provided with a display portion 902b, a detachable camera 903b, an input unit 904b incorporated in the housing 901b, a keyboard 905b, a mouse 906b, and a main body 907b.

The main body 907b includes at least a control unit.

The keyboard 905b and the mouse 906b can be used as other input units.

In the electronic device in FIG. 11B, detected information is obtained with the camera 903b, and the luminance of light emitted from the display portion 902b as a display unit can be controlled by the control unit inside the main body 907b. This structure makes it possible to reduce the user's eye fatigue and damage to the retina and prevent harm to the user's health.

An electronic device illustrated in FIG. 11C is an example of a laptop personal computer.

The electronic device in FIG. 11C includes a housing 901c in which a display portion 902c, a camera 903c, a keyboard 905c, and a pointing device 906c are incorporated.

Further, a control unit is provided inside the housing 901c.

In the electronic device in FIG. 11C, detected information is obtained with the camera 903c, and the luminance of light emitted from the display portion 902c as a display unit can be controlled by the control unit inside the housing 901c. This structure makes it possible to reduce the user's eye fatigue and damage to the retina and prevent harm to the user's health.

An electronic device of one embodiment of the present invention is not limited to the above structure, and may have any structure as long as it includes a control unit, a detection unit, and a display unit. Those units may be incorporated in respective housings.

This embodiment can be combined with any of the other embodiments disclosed in this specification as appropriate.

### Example

In this example, the results of studying the degrees of eye fatigue in different methods for driving a display device are described.

### Eye-Friendly Display

Nervous fatigue is caused by keeping looking at lighting or flashing for a long time because the retina or the nerve of an eye or the brain is stimulated by the light. A stimulus to a nerve or the brain might adversely affect the circadian rhythm.

Muscular fatigue is caused by heavy use of the ciliary muscle, which is used for focusing the eye on an object (adjusting focus). It is known that the closest distance at which an eye is focused on an object is lengthened owing to muscular fatigue.

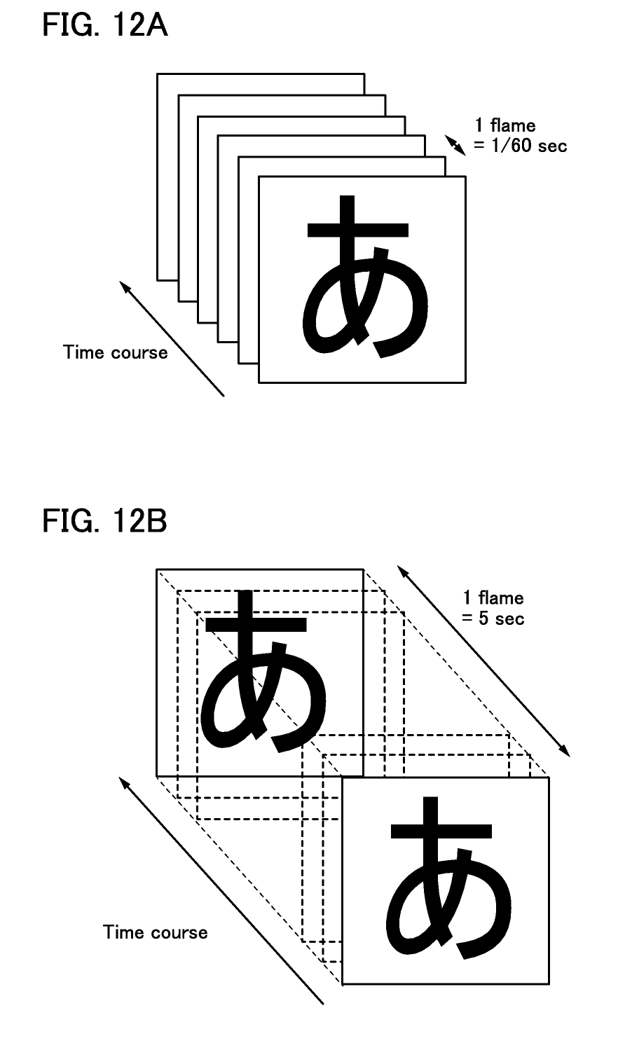

FIG. 12A is a schematic view showing display on a conventional display portion. As shown in FIG. 12A, an image is rewritten 60 times per second in the display on the conventional display portion. The retina or the nerve of an eye or the brain of a user is stimulated by keeping looking at such a screen for a long time and thus eye fatigue might be caused.

In one embodiment of the present invention, a transistor including an oxide semiconductor, for example, a transistor including a CAAC-OS, can be used in a pixel portion of a display portion. Since the off-state current of a transistor including an oxide semiconductor is extremely low, the luminance of the display portion can be maintained even with frame frequency lowered.

That is, as shown in FIG. 12B, an image can be rewritten as less frequently as once every five seconds, for example. This enables the user to see the same one image as long as possible, so that flicker on the screen recognized by the user is reduced. Consequently, a stimulus to the retina or the nerve of an eye or the brain of the user is relieved, resulting in less nervous fatigue.

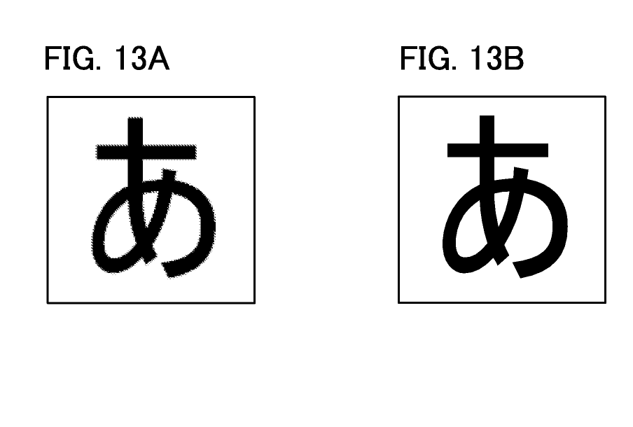

In addition, as shown in FIG. 13A, when the size of each pixel is large (for example, when the resolution is less than 150 ppi), a character displayed on the display portion is blurred. When a user keeps looking at a blurred character displayed on the display portion for a long time, it continues to be difficult to focus the eye on the character even though the ciliary muscle constantly moves in order to focus the eye, which might put strain on the eye.

In contrast, as shown in FIG. 13B, a display portion of one embodiment of the present invention is capable of high-resolution display because the size of each pixel is small; thus, smooth, high-resolution images can be displayed. In this case, the ciliary muscle can easily focus the eye on the character, so that the user's muscular fatigue is reduced. When the resolution of the display portion is 150 ppi or more, preferably 200 ppi or more, the user's muscular fatigue can be effectively reduced.

Methods for quantitatively measuring eye fatigue have been studied. For example, critical flicker (fusion) frequency (CFF) is known as an indicator for evaluating nervous fatigue. Further, accommodation time, near point distance, and the like are known as indicators for evaluating muscular fatigue.

Other methods for evaluating eye fatigue include electroencephalography, thermography, counting the number of times of blinking, measuring the amount of tears, measuring the speed of contractile response of the pupil, and questionnaires for surveying subjective symptoms.

Light with wavelengths shorter than or equal to 500 nm, particularly light with wavelengths shorter than or equal to 420 nm has high energy and thus partly reaches the retina of an eye without being absorbed by the cornea or the lens, thereby causing eye fatigue. Moreover, light with such wavelengths might have long-term effects on the retina (e.g., age-related macular degeneration). Further, exposure to the light until midnight might bring about adverse effects on the circadian rhythm. Those who have light-colored eyes are particularly subject to the effect of short-wavelength light because of low proportion of melanin pigments, which absorb such light, in the iris.

In addition, short-wavelength light tends to be scattered and thus causes a character or an image displayed in a pixel portion to appear blurred, for example. In focusing the eye on the blurred character or image, the ciliary muscle, which contracts the pupil, is stimulated and eye fatigue is caused. For the above reasons, lowering the luminance of light with such wavelengths leads to effective reduction of eye fatigue of a user.

Accordingly, to perform eye-friendly display which causes less eye fatigue, it is preferable to arrange pixels in the display portion at a resolution of 150 ppi (pixel per inch) or more, preferably 200 ppi or more. Further, it is preferable that light emitted from the display portion do not include light with wavelengths shorter than or equal to 440 nm, preferably shorter than or equal to 420 nm. A display unit which includes such a display portion having a resolution of at least 150 ppi or more and emitting light from which light with wavelengths shorter than or equal to 420 nm is removed can reduce eye fatigue of a user (causes less eye fatigue). Accordingly, such a display unit can be referred to as a display unit capable of “eye-friendly” display.

### [Measurement of Fatigue Degree]

The degrees of eye fatigue in different methods for driving a display device were evaluated by using critical flicker (fusion) frequency and near point distance as indicators for objectively evaluating the degrees of eye fatigue.

When the frequency of flashing of light is increased, the light appears continuous. This phenomenon is called fusion, and the frequency at which light begins to appear continuous without flicker being recognized is referred to as critical flicker (fusion) frequency (CFF). CFF is lowered as nervous eye fatigue is increased.

CFF was measured with Roken Digital Flicker RDF-1 (digital flicker-measuring instrument manufactured by SIBATA SCIENTIFIC TECHNOLOGY LTD.).

An eye is focused on an object by expansion and contraction of the ciliary muscle surrounding the lens of the eye. This is called accommodation, and a distance to the closest point (near point) at which the eye is focused on the object is lengthened as muscular eye fatigue is increased.

The near point distance was measured with NP accommodometer (manufactured by Kowa Company, Ltd.).

### [Measurement Conditions]

Table 1 shows specifications of a display device which was used for the measurements.

TABLE 1

| Display Type | Transmissive |
|---|---|
| Screen Diagonal | 6.05 inch |
| Resolution | 768 (H) × 1024 × RGB (V) |
| Pixel Pitch | 120 μm (H) × 40 μm (V) |
| Pixel Density | 212 ppi |
| Source Driver | DeMUX integrated |
| Scan Driver | Integrated |
| Liquid Crystal Mode | TN mode |
| Cell Gap | 4 μm |
| Backplane | CAAC-IGZO |

A visual load was applied as follows: 77×50 arbitrary alphabets were displayed on the above display device, and testees performed a task of counting the number of predetermined character strings out of those alphabets for 15 consecutive minutes. The task was repeated four times with ten minute intervals therebetween. In the measurements, the display device was driven at refresh rates of 0.2 Hz and 60 Hz. The interior illuminance was 200 lux while the visual load was applied.

The testees were six people of ages between 20 and 49 (four males and two females).

### [Evaluation Results]

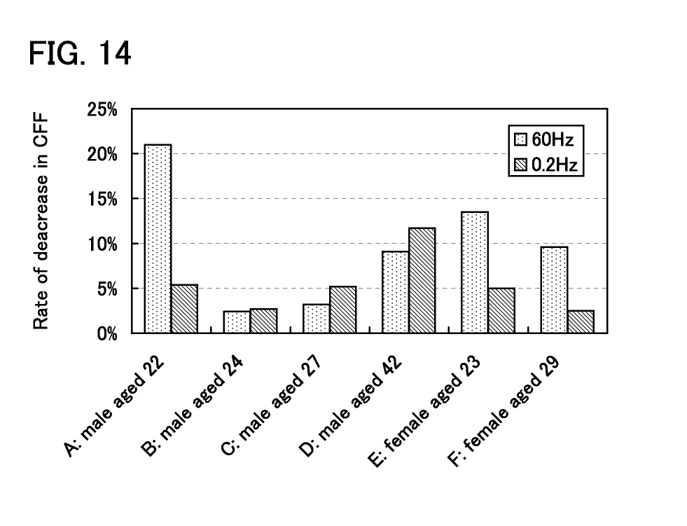

FIG. 14 shows the measurement results of CFF. FIG. 14 shows the rate of decrease in CFF due to the visual load for each testee. High rate of decrease indicates high fatigue degree. According to the results, as for the testees A, E, and F, the fatigue degree in 0.2 Hz driving was lower than that in 60 Hz driving. As for the testees B, C, and D, there was little difference between in 0.2 Hz driving and in 60 Hz driving. The results show that the eye-fatigue-reducing effect of low-frequency driving varies among individuals, but is greater for those who are relatively likely to be fatigued (sensitive to a visual load) than for those who are relatively less likely to be fatigued (insensitive to a visual load).

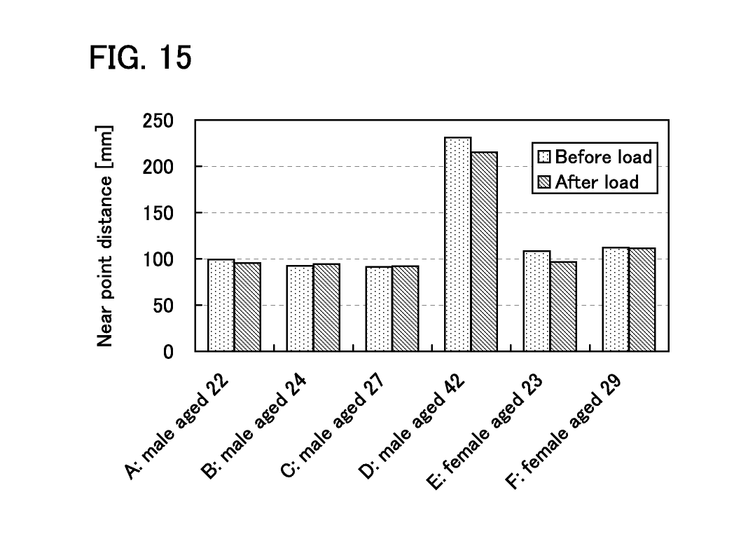

FIG. 15 shows the measurement results of near point distance. FIG. 15 shows near point distances before and after the application of the visual load in 60 Hz driving for each testee. There was only a slight change in near point distance due to the visual load for all the testees, which means that fatigue was not increased as greatly as to cause a visible change in near point distance under the conditions of visual load application employed here.

According to the above measurements, when a display unit which includes a display portion having a resolution of 150 ppi or more and emitting light from which light with wavelengths shorter than or equal to 420 nm is removed is used and the display device is driven at low refresh rate, eye fatigue is reduced and eye-friendly display can be achieved.

Note that this example can be implemented in combination with any of the embodiments described in this specification as appropriate.

This application is based on Japanese Patent Application serial no. 2012-234121 filed with Japan Patent Office on Oct. 23, 2012 and Japanese Patent Application serial no. 2012-262310 filed with Japan Patent Office on Nov. 30, 2012, the entire contents of which are hereby incorporated by reference.

What is claimed is:

1. A display device comprising:
a display unit;
a detection unit; and
a control unit,
wherein the detection unit is configured to detect a condition of a user's eye to obtain first information and transmit the first information to the control unit, and
wherein the control unit is configured to extract second information from the first information and drive the display unit such that a luminance of light with a wavelength shorter than or equal to a predetermined wavelength among light emitted from the display unit is changed on the basis of the second information.

2. The display device according to claim 1, wherein the control unit is configured to drive the display unit such that a display refresh rate is changed on the basis of the second information.

3. The display device according to claim 2,
wherein the display refresh rate has two different modes,
wherein the display refresh rate in a first mode is higher than or equal to 30 Hz and lower than 960 Hz, and
wherein the display refresh rate in a second mode is higher than or equal to 1.16×10⁻⁵ Hz and lower than or equal to 10 Hz.

4. The display device according to claim 1,
wherein the control unit includes a storage unit storing setting information, and
wherein the control unit is configured to drive the display unit on the basis of both the second information and the setting information.

5. The display device according to claim 1, wherein the predetermined wavelength is 420 nm.

6. The display device according to claim 1, wherein the second information is fatigue information on the user.

7. A storage medium storing a program for driving a display device,
the display device including a display unit, a detection unit, a control unit, and an arithmetic device,
the program comprising the steps of:
making the detection unit detect a condition of a user's eye to obtain first information and transmit the first information to the control unit; and
making the control unit extract second information from the first information and drive the display unit such that a luminance of light with a wavelength shorter than or equal to a predetermined wavelength among light emitted from the display unit is changed on the basis of the second information,
wherein the arithmetic device executes the program.

8. The storage medium according to claim 7, wherein the program further comprises the step of making the control unit drive the display unit such that a display refresh rate is changed on the basis of the second information.

9. The storage medium according to claim 8,
wherein the display refresh rate has two different modes,
wherein the display refresh rate in a first mode is higher than or equal to 30 Hz and lower than 960 Hz, and
wherein the display refresh rate in a second mode is higher than or equal to 1.16×10⁻⁵ Hz and lower than or equal to 10 Hz.

10. The storage medium according to claim 7,
wherein the control unit includes a storage unit,
wherein the program further comprises the step of making the control unit read out setting information stored in advance in the storage unit, and
wherein the control unit drives the display unit on the basis of both the second information and the setting information.

11. The storage medium according to claim 10, wherein the program further comprises the step of making the control unit drive the display unit so that a display refresh rate is changed on the basis of both the second information and the setting information.

12. The storage medium according to claim 11,
wherein the display refresh rate has two different modes,
wherein the display refresh rate in a first mode is higher than or equal to 30 Hz and lower than 960 Hz, and
wherein the display refresh rate in a second mode is higher than or equal to 1.16×10⁻⁵ Hz and lower than or equal to 10 Hz.

13. The storage medium according to claim 7, wherein the predetermined wavelength is 420 nm.

14. The storage medium according to claim 7, wherein the second information is fatigue information on the user.

15. A method for driving a display device,
the display device including a display unit, a detection unit, and a control unit,
the method comprising the steps of:
detecting a condition of a user's eye by the detection unit to obtain first information;
transmitting the first information from the detection unit to the control unit;
extracting second information from the first information by the control unit; and
driving the display unit by the control unit such that a luminance of light with a wavelength shorter than or equal to a predetermined wavelength among light emitted from the display unit is changed on the basis of the second information.

16. The method according to claim 15, further comprising the step of:
driving the display unit by the control unit such that a display refresh rate is changed on the basis of the second information.

17. The method according to claim 16,
wherein the display refresh rate has two different modes,
wherein the display refresh rate in a first mode is higher than or equal to 30 Hz and lower than 960 Hz, and
wherein the display refresh rate in a second mode is higher than or equal to 1.16×10⁻⁵ Hz and lower than or equal to 10 Hz.

18. The method according to claim 15,
wherein the control unit includes a storage unit storing setting information, and
wherein the control unit drives the display unit on the basis of both the second information and the setting information.

19. The method according to claim 15, wherein the predetermined wavelength is 420 nm.

20. The method according to claim 15, wherein the second information is fatigue information on the user.
